(19) United States
(12) Patent Application Publication
(10) Pub. No.: US 2025/0340079 A1
(43) Pub. Date: Nov. 6, 2025

(54) THERMAL TRANSFER SHEET, DISCOLORED OR DECOLORIZED PRINTED MATERIAL, AND METHOD FOR PRODUCING DISCOLORED OR DECOLORIZED PRINTED MATERIAL

(71) Applicant: DAI NIPPON PRINTING CO., LTD., Tokyo (JP)

(72) Inventors: Yuki IWASAKI, Tokyo (JP); Ryoji HATTORI, Tokyo (JP); Hiroshi EGUCHI, Tokyo (JP)

(73) Assignee: DAI NIPPON PRINTING CO., LTD., Tokyo (JP)

(21) Appl. No.: 19/267,742

(22) Filed: Jul. 14, 2025

Related U.S. Application Data
(62) Division of application No. 18/000,167, filed on Nov. 29, 2022.

(30) Foreign Application Priority Data
Jun. 12, 2020 (JP) 2020-102723

(51) Int. Cl. B41M 5/34; B41M 5/333; B41M 5/46; B41M 5/48

(52) U.S. Cl. CPC B41M 5/34; B41M 5/333; B41M 5/46; B41M 5/48

(57) ABSTRACT

A thermal transfer sheet according to an embodiment of the present disclosure includes a substrate and a sublimation transfer discoloration- or decolorization-imparting layer disposed on one surface side of the substrate, in which the sublimation transfer discoloration- or decolorization-imparting layer contains at least a compound responsible for discoloration or decolorization and a binder resin.

### CROSS REFERENCE TO RELATED APPLICATIONS

This application is a division of U.S. application Ser. No. 18/000,167, filed Nov. 29, 2022, which in turn is the National Stage entry of International Application No. PCT/JP2021/022068, filed Jun. 10, 2021, which designated the United States, the entireties of which are incorporated herein by reference.

### TECHNICAL FIELD

The present disclosure relates to a thermal transfer sheet, a combination of a thermal transfer sheet and an intermediate transfer medium, a thermal transfer printed material, a method for producing a thermal transfer printed material, a discolored or decolorized printed material, and a method for producing a discolored or decolorized printed material.

### BACKGROUND ART

Various thermal transfer methods have been employed as methods for producing printed materials. For example, a method for forming a thermal transfer image on a transfer-receiving article by using a thermofusible transfer method or a sublimation thermal transfer method is known.

In conventional printed materials, various efforts have been made to ensure that images formed on transfer-receiving articles do not change. However, in recent years, as the applications of printed materials have expanded, there has been a demand for printed materials having various functions and characteristics. In recent years, there has also been a demand for printed materials with no surface unevenness and with a good planar design.

### SUMMARY OF THE INVENTION

### Technical Problem

It is an object of the present disclosure to provide a thermal transfer sheet and a combination of the thermal transfer sheet and an intermediate transfer medium, the sheet and the combination being capable of producing a thermal transfer printed material that can discolor or decolorize an image and that has a good design.

It is another object of the present disclosure to provide a thermal transfer printed material that can discolor or decolorize an image and that has a good design, and a method for producing the thermal transfer printed material.

It is another object of the present disclosure to provide a discolored or decolorized printed material in which an image is discolored or decolorized and which has a good design, and a method for producing the discolored or decolorized printed material.

### Solution to Problem

According to the present disclosure, a thermal transfer sheet includes a substrate and a sublimation transfer discoloration- or decolorization-imparting layer disposed on one surface side of the substrate,
in which the sublimation transfer discoloration- or decolorization-imparting layer contains at least a compound responsible for discoloration or decolorization and a binder resin.

According to the present disclosure, a thermal transfer printed material includes a transfer-receiving article, a general image, and a sublimation transfer discoloration- or decolorization-imparting image,
in which the sublimation transfer discoloration- or decolorization-imparting image is in contact with at least part of the general image and contains a compound responsible for discoloration or decolorization.

According to the present disclosure, a method for producing the thermal transfer printed material described above includes the steps of:
providing the thermal transfer sheet described above and a transfer-receiving article; and
forming a general image and a sublimation transfer discoloration- or decolorization-imparting image on the transfer-receiving article in such a manner that the general image and the sublimation transfer discoloration- or decolorization-imparting image are in contact with each other,
in which the sublimation transfer discoloration- or decolorization-imparting image is formed from the sublimation transfer discoloration- or decolorization-imparting layer of the thermal transfer sheet.

According to the present disclosure, a discolored or decolorized printed material includes a transfer-receiving article and a discolored or decolorized portion,
in which the discolored or decolorized portion contains a reaction product of a coloring material and a compound responsible for discoloration or decolorization.

According to the present disclosure, a method for producing the discolored or decolorized printed material described above includes:
a step of providing the thermal transfer printed material described above; and
a light irradiation step of performing irradiation with a light beam having a predetermined intensity for a predetermined period of time from a side of the thermal transfer printed material adjacent to the general image and the sublimation transfer discoloration- or decolorization-imparting image to discolor or decolorize the general image.

According to the present disclosure, provided is a combination of the thermal transfer sheet described above and an intermediate transfer medium,
in which the intermediate transfer medium includes at least a substrate and a retransfer layer, and
the retransfer layer includes at least a receiving layer.

According to the present disclosure, a thermal transfer printed material includes a transfer-receiving article and a retransfer layer,
in which the retransfer layer includes at least a receiving layer, a general image, and a sublimation transfer discoloration- or decolorization-imparting image, and
the sublimation transfer discoloration- or decolorization-imparting image is in contact with at least part of the general image and contains a compound responsible for discoloration or decolorization.

According to the present disclosure, a method for producing the thermal transfer printed material described above includes the steps of:
providing the combination of the thermal transfer sheet and the intermediate transfer medium described above and the transfer-receiving article;
forming the general image and the sublimation transfer discoloration- or decolorization-imparting image on the receiving layer of the intermediate transfer medium in such a manner that the general image and the sublimation transfer discoloration- or decolorization-imparting image are in contact with each other; and
transferring the retransfer layer including at least the receiving layer, the general image, and the sublimation transfer discoloration- or decolorization-imparting image to the transfer-receiving article,
in which the sublimation transfer discoloration- or decolorization-imparting image is formed from the sublimation transfer discoloration- or decolorization-imparting layer of the thermal transfer sheet.

According to the present disclosure, a discolored or decolorized printed material includes a transfer-receiving article and a discolored or decolorized retransfer layer,
in which the discolored or decolorized retransfer layer includes at least a receiving layer and a discolored or decolorized portion, and
the discolored or decolorized portion contains a reaction product of a coloring material and a compound responsible for discoloration or decolorization.

According to the present disclosure, a method for producing the discolored or decolorized printed material described above includes:
a step of providing the thermal transfer printed material described above; and
a light irradiation step of performing irradiation with a light beam having a predetermined intensity for a predetermined period of time from a side of the thermal transfer printed material adjacent to the retransfer layer to discolor or decolorize the general image.

### Advantageous Effects of Invention

According to the present disclosure, it is possible to provide the thermal transfer sheet and the combination of the thermal transfer sheet and the intermediate transfer medium, the sheet and the combination being capable of producing a thermal transfer printed material that can discolor or decolorize an image and that has a good design.

According to the present disclosure, it is possible to provide the thermal transfer printed material capable of discoloring or decolorizing an image and having a good design, and a method for producing the thermal transfer printed material.

According to the present disclosure, it is possible to provide the discolored or decolorized printed material in which an image is discolored or decolorized and which has a good design, and a method for producing the discolored or decolorized printed material.

### BRIEF DESCRIPTION OF THE DRAWINGS

FIG. 1 is a schematic cross-sectional view illustrating an embodiment of a thermal transfer sheet of the present disclosure.

FIG. 2 is a schematic cross-sectional view illustrating an embodiment of a thermal transfer sheet of the present disclosure.

FIG. 3 is a schematic cross-sectional view illustrating an embodiment of a thermal transfer sheet of the present disclosure.

FIG. 4 is a schematic cross-sectional view illustrating an embodiment of a thermal transfer sheet of the present disclosure.

FIG. 5 is a schematic cross-sectional view illustrating an embodiment of a thermal transfer sheet of the present disclosure.

FIG. 6 is a schematic cross-sectional view illustrating an embodiment of a combination of a thermal transfer sheet and an intermediate transfer medium according to the present disclosure.

FIG. 7 is a schematic cross-sectional view illustrating an embodiment of a thermal transfer printed material of a first form.

FIG. 8 is a schematic cross-sectional view illustrating an embodiment of a thermal transfer printed material of a first form.

FIG. 9 is a schematic cross-sectional view illustrating an embodiment of a thermal transfer printed material of a first form.

FIG. 10 is a schematic cross-sectional view illustrating an embodiment of a thermal transfer printed material of a first form.

FIG. 11 is a schematic cross-sectional view illustrating an embodiment of a thermal transfer printed material of a first form.

FIG. 12 is a schematic cross-sectional view illustrating an embodiment of a thermal transfer printed material of a first form.

FIG. 13 is a schematic cross-sectional view illustrating an embodiment of a thermal transfer printed material of a first form.

FIG. 14 is a schematic cross-sectional view illustrating an embodiment of a thermal transfer printed material of a first form.

FIG. 15 is a schematic cross-sectional view illustrating an embodiment of a discolored or decolorized printed material of a first form.

FIG. 16 is a schematic cross-sectional view illustrating an embodiment of a discolored or decolorized printed material of a first form.

FIG. 17 is a schematic cross-sectional view illustrating an embodiment of a discolored or decolorized printed material of a first form.

FIG. 18 is a schematic cross-sectional view illustrating an embodiment of a discolored or decolorized printed material of a first form.

FIG. 19 is a schematic view partially illustrating an embodiment of a method for producing a discolored or decolorized printed material of a first form.

FIG. 20 is a schematic cross-sectional view illustrating an embodiment of a thermal transfer printed material of a second form.

FIG. 21 is a schematic cross-sectional view illustrating an embodiment of a thermal transfer printed material of a second form.

FIG. 22 is a schematic cross-sectional view illustrating an embodiment of a thermal transfer printed material of a second form.

FIG. 23 is a schematic cross-sectional view illustrating an embodiment of a thermal transfer printed material of a second form.

FIG. 24 is a schematic cross-sectional view illustrating an embodiment of a thermal transfer printed material of a second form.

FIG. 25 is a schematic cross-sectional view illustrating an embodiment of a thermal transfer printed material of a second form.

FIG. 26 is a schematic cross-sectional view illustrating an embodiment of a thermal transfer printed material of a second form.

FIG. 27 is a schematic cross-sectional view illustrating an embodiment of a thermal transfer printed material of a second form.

FIG. 28 is a schematic cross-sectional view illustrating an embodiment of a discolored or decolorized printed material of a second form.

FIG. 29 is a schematic cross-sectional view illustrating an embodiment of a discolored or decolorized printed material of a second form.

FIG. 30 is a schematic cross-sectional view illustrating an embodiment of a discolored or decolorized printed material of a second form.

FIG. 31 is a schematic cross-sectional view illustrating an embodiment of a discolored or decolorized printed material of a second form.

FIG. 32 is a schematic view partially illustrating an embodiment of a method for producing a discolored or decolorized printed material of a second form.

### DESCRIPTION OF EMBODIMENTS

### [Thermal Transfer Sheet]

A thermal transfer sheet according to the present disclosure includes a substrate and a sublimation transfer discoloration- or decolorization-imparting layer disposed on one surface side of the substrate. This makes it possible to provide a thermal transfer printed material that can discolor or decolorize a general image and that has a good design.

The thermal transfer sheet may include a coloring material layer and a sublimation transfer discoloration- or decolorization-imparting layer, which are disposed as being frame sequentially on the same surface.

The thermal transfer sheet of the present disclosure will be described below with reference to the drawings.

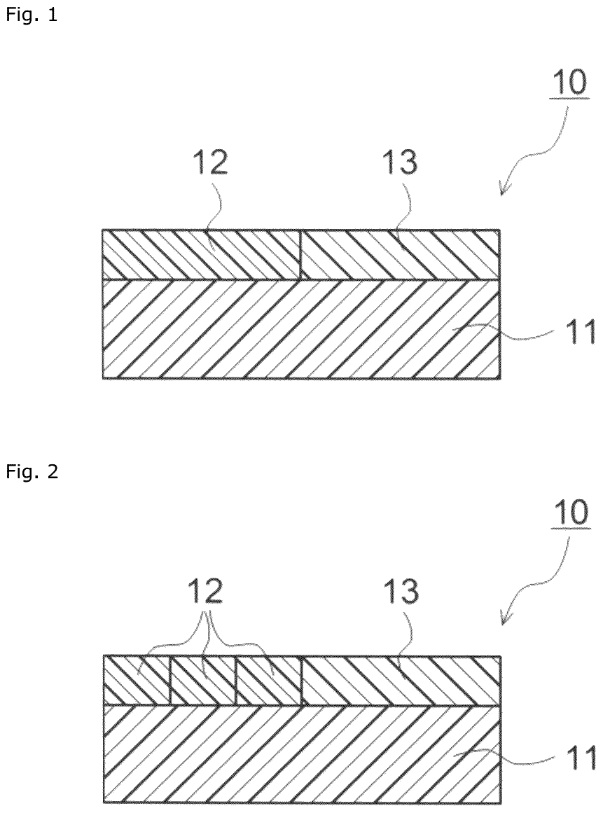

As illustrated in FIG. 1, a thermal transfer sheet 10 according to an embodiment includes a substrate 11, a coloring material layer 12, and a sublimation transfer discoloration- or decolorization-imparting layer 13, in which these layers are disposed as being frame sequentially on one surface of the substrate 11.

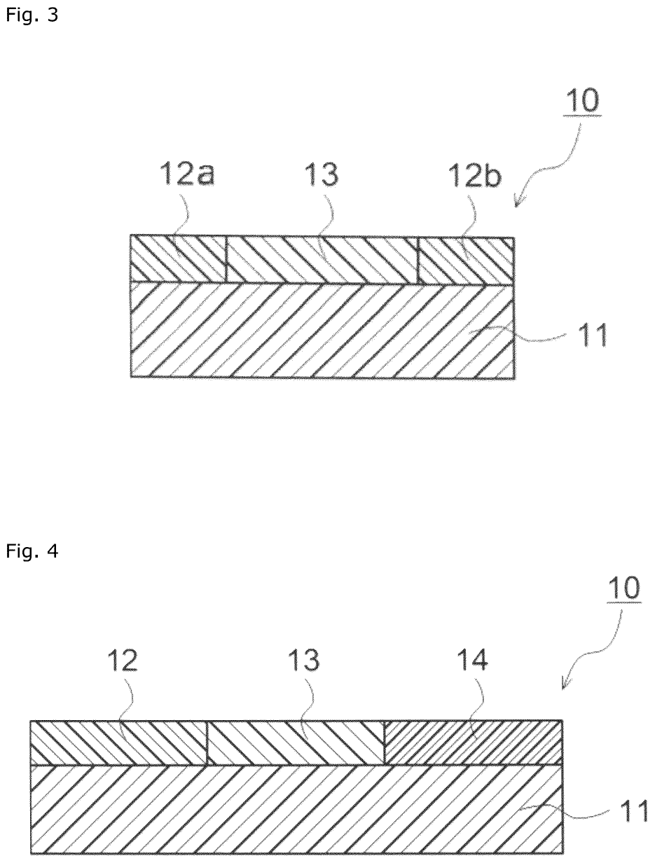

As illustrated in FIG. 2, the thermal transfer sheet 10 according to an embodiment includes the substrate 11, the coloring material layer 12, and the sublimation transfer discoloration- or decolorization-imparting layer 13, in which these layers are disposed as being frame sequentially on one surface of the substrate 11. As illustrated in FIG. 2, with regard to the coloring material layer 12, multiple coloring material layers 12 are disposed as being frame sequentially on the same surface.

As illustrated in FIG. 3, the thermal transfer sheet 10 according to an embodiment includes the substrate 11, a coloring material layer 12a, the sublimation transfer discoloration- or decolorization-imparting layer 13, and a coloring material layer 12b, in which these layers are disposed as being frame sequentially on one surface of the substrate 11. With regard to the coloring material layer 12a and/or the coloring material layer 12b, multiple coloring material layers 12a and multiple coloring material layers 12b may be disposed as being frame sequentially on the same surface (not illustrated).

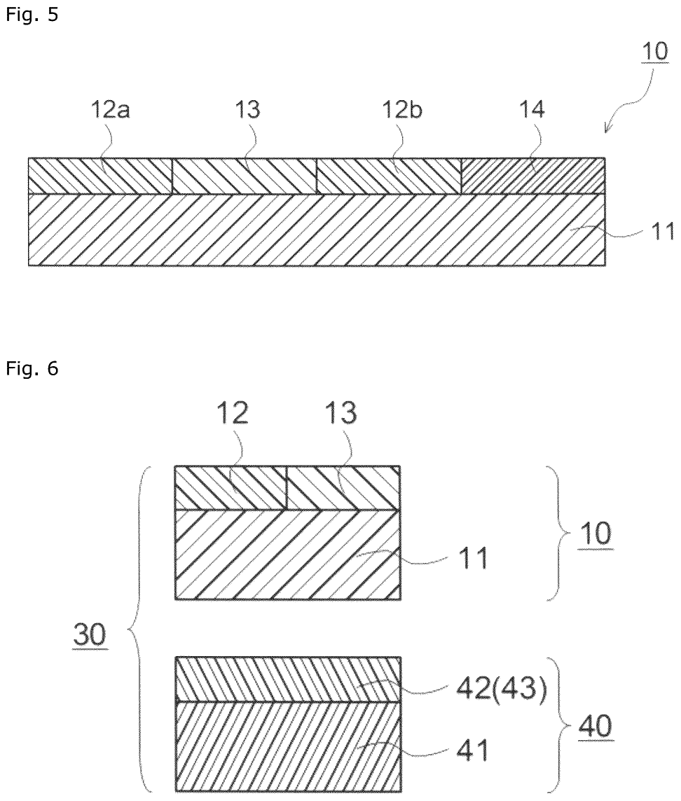

As illustrated in FIG. 4, the thermal transfer sheet 10 according to an embodiment includes the substrate 11, the coloring material layer 12, the sublimation transfer discoloration- or decolorization-imparting layer 13, and a protective layer 14, in which these layers are disposed as being frame sequentially on one surface of the substrate 11. The coloring material layer 12, the sublimation transfer discoloration- or decolorization-imparting layer 13, and the protective layer 14 may be disposed in the order of the coloring material layer 12, the sublimation transfer discoloration- or decolorization-imparting layer 13, and the protective layer 14 (FIG. 4), or may be disposed in the order of the sublimation transfer discoloration- or decolorization-imparting layer 13, the coloring material layer 12, and the protective layer 14 (not illustrated). With regard to the coloring material layer 12, multiple coloring material layers 12 may be disposed as being frame sequentially on the same surface (not illustrated).

As illustrated in FIG. 5, the thermal transfer sheet 10 according to an embodiment includes the substrate 11, the coloring material layer 12a, the sublimation transfer discoloration- or decolorization-imparting layer 13, the coloring material layer 12b, and the protective layer 14, in which these layers are disposed as being frame sequentially on one surface of the substrate 11. With regard to the coloring material layer 12a and/or the coloring material layer 12b, multiple coloring material layers 12a and multiple coloring material layers 12b may be disposed as being frame sequentially on the same surface (not illustrated).

The thermal transfer sheet 10 may include a peeling layer (not illustrated) between the substrate 11 and the coloring material layer 12 and/or the protective layer 14.

The thermal transfer sheet 10 may include a primer layer (not illustrated) between the substrate 11 and the coloring material layer 12 and/or the sublimation transfer discoloration- or decolorization-imparting layer 13.

The thermal transfer sheet 10 may include a release layer (not illustrated) between the substrate 11 and at least one layer selected from the coloring material layer 12, the protective layer 14, and the peeling layer.

The thermal transfer sheet 10 may include a back layer (not illustrated) on a side of the substrate 11 opposite to the side on which the coloring material layer 12 and the sublimation transfer discoloration- or decolorization-imparting layer 13 are disposed.

The sublimation transfer discoloration- or decolorization-imparting layer 13 may be disposed on the entire surface or part of the protective layer 14.

The above-described layer configurations of the thermal transfer sheet 10 can be combined as appropriate.

Each of the layers that can be included in the thermal transfer sheet of the present disclosure will be described below.

### <Substrate>

The substrate of the thermal transfer sheet has heat resistance to thermal energy applied during thermal transfer, mechanical strength that can support each layer disposed on the substrate, and solvent resistance.

As the substrate of the thermal transfer sheet, a film composed of a resin material (hereinafter, simply referred to as a “resin film”) can be used. Examples of the resin material include polyesters, such as poly(ethylene terephthalate) (PET), poly(butylene terephthalate) (PBT), poly(ethylene naphthalate) (PEN), 1,4-poly(cyclohexylenedimethylene terephthalate), terephthalic acid-cyclohexanedimethanol-ethylene glycol copolymers; polyamides, such as nylon 6 and nylon 6,6; polyolefins, such as polyethylene (PE), polypropylene (PP), and polymethylpentene; vinyl resins, such as poly(vinyl chloride), poly(vinyl alcohol) (PVA), poly(vinyl acetate), vinyl chloride-vinyl acetate copolymers, poly(vinyl butyral), and poly(vinyl pyrrolidone) (PVP); (meth)acrylic resins, such as polyacrylate, polymethacrylate, and poly(methyl methacrylate); imide resins, such as polyimide and poly(ether imide); cellulose resins, such as cellophane, cellulose acetate, nitrocellulose, cellulose acetate propionate (CAP), and cellulose acetate butylate (CAB); styrene resins, such as polystyrene (PS); polycarbonate; and ionomer resins.

Among the above resins, polyesters, such as PET and PEN, are preferred, and PET is particularly preferred, from the viewpoints of heat resistance and mechanical strength.

In the present disclosure, the term “(meth)acrylic” includes both “acrylic” and “methacrylic”. The term “(meth)acrylate” includes both “acrylate” and “methacrylate”.

A laminate including the above-described resin film can also be used as the substrate. The laminate of the resin film can be produced by the use of, for example, a dry lamination method, a wet lamination method, or an extrusion method.

When the substrate of the thermal transfer sheet is a resin film, the resin film may be a stretched film or an unstretched film. The resin film is preferably uniaxially or biaxially stretched film from the viewpoint of strength.

The substrate of the thermal transfer sheet preferably has a thickness of 2 μm or more and 25 μm or less, more preferably 3 μm or more and 16 μm or less. This can result in good mechanical strength of the substrate and good thermal energy transfer during the thermal transfer.

### <Sublimation Transfer Discoloration- or Decolorization-Imparting Layer>

The sublimation transfer discoloration- or decolorization-imparting layer contains at least a compound responsible for discoloration or decolorization and a binder. The application of energy sublimes or diffuses the compound responsible for discoloration or decolorization, thereby transferring the compound to a transfer-receiving article or a receiving layer. Since the compound responsible for discoloration or decolorization has sublimability or diffusibility, the thermal transfer printed material can have a surface with suppressed unevenness and a good design. Since the amount of sublimation transfer discoloration- or decolorization-imparting layer transferred by sublimation can be adjusted by printing energy, the degree of discoloration or decolorization of the image can be easily adjusted.

The sublimation transfer discoloration- or decolorization-imparting layer is a layer containing a compound responsible for discoloration or decolorization. The compound responsible for discoloration or decolorization contained in the sublimation transfer discoloration- or decolorization-imparting layer is a compound having sublimability or diffusibility and the function of discoloring or decolorizing an image. Examples of the mechanism of discoloring or decolorizing an image include a reaction of the compound responsible for discoloration or decolorization and a component, such as a coloring material, contained in the image; and the initiation of a reaction of the component in the image. Examples of the reaction include decomposition, breakdown, and polymerization of the component. The sublimation transfer discoloration- or decolorization-imparting layer contains the compound responsible for discoloration or decolorization and thus can discolor or decolorize the image of the thermal transfer printed material.

The compound responsible for discoloration or decolorization is preferably a compound that reacts with or initiates a reaction with an image component by light irradiation. The compound responsible for discoloration or decolorization is more preferably an acid-generating material that can generate an acid by light irradiation. A nonionic acid-generating material is more preferred because it has good sublimability or diffusibility and good sublimation transferability.

Examples of the nonionic acid-generating material include azine compounds, such as monoazine compounds, diazine compounds, and triazine compounds, halogen-containing compounds, and carbamate compounds. The nonionic acid-generating material is preferably a triazine compound, more preferably a halogen-containing triazine compound.

“Light irradiation” may be, for example, sunlight, fluorescent lamp irradiation, or xenon lamp irradiation.

The compound responsible for discoloration or decolorization preferably has a molecular weight of 1,000 or less, more preferably 100 or more and 800 or less, even more preferably 200 or more and 600 or less. This can further improve the transferability of the sublimation transfer discoloration- or decolorization-imparting layer.

In the sublimation transfer discoloration- or decolorization-imparting layer, a solid content of the compound responsible for discoloration or decolorization is preferably 10% or more by mass and 90% or less by mass, more preferably 15% or more by mass and 85% or less by mass, even more preferably 25% or more by mass and 80% or less by mass, based on the total component contained in the sublimation transfer discoloration- or decolorization-imparting layer. This can further improve discoloration or decolorization properties in the thermal transfer printed material.

The sublimation transfer discoloration- or decolorization-imparting layer contains at least one binder. Examples of the binder contained in the sublimation transfer discoloration- or decolorization-imparting layer include polyolefins, vinyl resins, vinyl acetal resins, (meth)acrylic resins, cellulose resins, polyesters, epoxy resins, polyamides, polycarbonates, styrene resins, polyurethanes, phenoxy resins, and ionomer resins.

The sublimation transfer discoloration- or decolorization-imparting layer preferably has a resin material content of 10% or more by mass and 90% or less by mass, more preferably 15% or more by mass and 85% or less by mass, even more preferably 20% or more by mass and 75% or less by mass, based on the total component contained in the sublimation transfer discoloration- or decolorization-imparting layer. This can further improve discoloration or decolorization properties in the thermal transfer printed material.

The sublimation transfer discoloration- or decolorization-imparting layer may contain an additive. Examples of the additive include fillers, plasticizers, antistatic agents, ultraviolet absorbers, inorganic particles, metal particles, release materials, and dispersants.

The sublimation transfer discoloration- or decolorization-imparting layer preferably has a thickness of 0.2 μm or more and 10 μm or less, more preferably 0.4 μm or more and 5 μm or less. This can further improve discoloration or decolorization properties in the thermal transfer printed material.

The sublimation transfer discoloration- or decolorization-imparting layer can be formed by dispersing or dissolving the above-described materials in an appropriate solvent to prepare a coating liquid, applying the coating liquid onto, for example, the substrate or the primer layer to form a coating film, and drying the coating film. As the coating means, known means, such as a roll coating method, a reverse roll coating method, a gravure coating method, a reverse gravure coating method, a bar coating method, or a rod coating method, can be used.

### <Coloring Material Layer>

The coloring material layer is a layer used to form a general image. The coloring material layer may be a sublimation transfer coloring material layer, in which a sublimation dye contained in the coloring material layer is to be transferred, or may be a fusion transfer coloring material layer, in which the coloring material layer itself is to be transferred. The thermal transfer sheet of the present disclosure may include both the sublimation transfer coloring material layer and the fusion transfer coloring material layer.

The coloring material layer contains at least one coloring material. The coloring material contained in the coloring material layer may be a pigment or a dye. The dye may be a sublimation dye.

Examples of the pigment include carbon black, acetylene black, lamp black, black smoke, iron black, aniline black, silica, calcium carbonate, titanium oxide, cadmium red, cadmopone red, chromium red, vermilion, colcothar, azo-based pigments, alizarin lake, quinacridone, cochineal lake perylene, yellow ocher, aureolin, cadmium yellow, cadmium orange, chromium yellow, zinc yellow, naples yellow, nickel yellow, azo-based pigments, greenish yellow, ultramarine, blue verditer, cobalt, phthalocyanine, anthraquinone, indigoid, cinnabar green, cadmium green, chromium green, phthalocyanine, azomethine, perylene, and aluminum pigments.

Examples of the dye include diarylmethane dyes, triarylmethane dyes, thiazole dyes, merocyanine dyes, pyrazolone dyes, methine dyes, indoaniline dyes, acetophenone azomethine dyes, pyrazolo azomethine dyes, xanthene dyes, oxazine dyes, thiazine dyes, azine dyes, acridine dyes, azo dyes, spiropyran dyes, indolinospiropyran dyes, fluoran dyes, naphthoquinone dyes, anthraquinone dyes, and quinophthalone dyes.

The coloring material layer may contain at least one resin material. Examples of the resin material contained in the coloring material layer include polyesters, polyamides, polyolefins, vinyl resins, vinyl acetal resins, (meth)acrylic resins, cellulose resins, styrene resins, polycarbonates, phenoxy resins, and ionomer resins.

The coloring material layer may contain the above-described additive.

The coloring material layer has a thickness of, for example, 0.1 μm or more and 3 μm or less.

The coloring material layer can be formed by dispersing or dissolving the above-described material in an appropriate solvent to prepare a coating liquid, applying the coating liquid onto, for example, the substrate, the peeling layer, the primer layer, or the release layer by the above-described application means to form a coating film, and drying the coating film.

### <Protective Layer>

The protective layer of the thermal transfer sheet is a layer to be transferred from the thermal transfer sheet onto an intermediate transfer medium or onto the thermal transfer printed material. The thermal transfer sheet including the protective layer can protect the image of the thermal transfer printed material.

The protective layer of the thermal transfer sheet may contain at least one resin material. Examples of the resin material contained in the protective layer include (meth)acrylic resins, polyesters, cellulose resins, styrene resins, polyamides, vinyl resins, polycarbonates, silicone resins, hydroxy group-containing resins, thermosetting resins, and actinic radiation-curable resins.

The protective layer of the thermal transfer sheet has a resin material content of, for example, 50% or more by mass and 90% or less by mass.

The protective layer of the thermal transfer sheet may contain the above-described additive.

The protective layer of the thermal transfer sheet has a thickness of, for example, 0.5 μm or more and 10 μm or less.

The protective layer of the thermal transfer sheet can be formed by dispersing or dissolving the above-described material in an appropriate solvent to prepare a coating liquid, applying the coating liquid onto, for example, the substrate, the peeling layer, or the release layer by the above-described application means to form a coating film, and drying the coating film.

### <Peeling Layer>

The peeling layer of the thermal transfer sheet is a layer to be transferred from the thermal transfer sheet onto the intermediate transfer medium or the thermal transfer printed material. The thermal transfer sheet including the peeling layer can improve the transferability of the fusion transfer coloring material layer and the protective layer, which are disposed on the peeling layer.

The peeling layer of the thermal transfer sheet may contain at least one resin material. Examples of the resin material contained in the peeling layer include polyesters, polyamides, polyolefins, vinyl resins, (meth)acrylic resins, imide resins, cellulose resins, styrene resins, polycarbonates, and ionomer resins. The peeling layer preferably contains a (meth)acrylic resin, more preferably a poly(methyl methacrylate), from the viewpoint of transferability.

The peeling layer of thermal transfer sheet may contain the following release material and the foregoing additive.

The peeling layer of the thermal transfer sheet has a thickness of, for example, 0.1 μm or more and 3 μm or less.

The peeling layer of the thermal transfer sheet can be formed by dispersing or dissolving the above-described material in an appropriate solvent to prepare a coating liquid, applying the coating liquid onto, for example, the substrate or the release layer by the above-described application means to form a coating film, and drying the coating film.

### <Primer Layer>

The primer layer is a layer that remains on the substrate during thermal transfer of the thermal transfer sheet. The thermal transfer sheet including the primer layer can improve the adhesion between freely-selected layers.

The thermal transfer sheet preferably includes the primer layer between the substrate and the sublimation transfer discoloration- or decolorization-imparting layer. When the coloring material layer is a sublimation transfer layer, the thermal transfer sheet preferably includes the primer layer between the substrate and the coloring material layer.

The primer layer may contain at least one resin material. Examples of the resin material contained in the primer layer include polyesters, vinyl resins, such as PVA and PVP, polyurethanes, (meth)acrylic resins, polyamides, polyethers, styrene resins, and cellulose resins.

The primer layer may contain the above-described additive.

The primer layer has a thickness of, for example, 0.05 μm or more and 2.0 μm or less.

The primer layer can be formed by dispersing or dissolving the above-described material in an appropriate solvent to prepare a coating liquid, applying the coating liquid onto, for example, the substrate by the above-described application means to form a coating film, and drying the coating film.

### <Release Layer>

The release layer of the thermal transfer sheet is a layer disposed between the substrate and the coloring material layer, the protective layer, the peeling layer, and so forth and remains on the substrate during the thermal transfer of the thermal transfer sheet. The thermal transfer sheet including the release layer can improve transferability.

The release layer of the thermal transfer sheet may contain at least one resin material. Examples of the resin material contained in the release layer include (meth)acrylic resins, polyurethanes, acetal resins, polyamides, polyesters, melamine resins, polyol resins, cellulose resins, and silicone resins.

The release layer of the thermal transfer sheet may contain at least one release material. Examples of the release material include fluorine compounds, phosphate compounds, silicone oils, higher fatty acid amide compounds, metal soap, and waxes, such as paraffin wax.

The release layer of the thermal transfer sheet preferably has a release material content of 0.1% or more by mass and 10% or less by mass, more preferably 0.5% or more by mass and 5% or less by mass. This can further improve the transferability of each layer.

The release layer of the thermal transfer sheet may contain the above-described additive.

The release layer of the thermal transfer sheet has a thickness of, for example, 0.1 μm or more and 2.0 μm or less.

The release layer of the thermal transfer sheet can be formed by dispersing or dissolving the above-described material in an appropriate solvent to prepare a coating liquid, applying the coating liquid onto, for example, the substrate by the above-described application means to form a coating film, and drying the coating film.

### <Back Layer>

The back layer is disposed on a side of the substrate opposite to the side on which the sublimation transfer discoloration- or decolorization-imparting layer is disposed. This can prevent the occurrence of sticking and wrinkling caused by heating during thermal transfer.

The back layer may contain at least one resin material. Examples of the resin material contained in the back layer include vinyl resins, polyesters, polyamides, polyolefins, (meth)acrylic resins, polyolefins, polyurethanes, cellulose resins, and phenolic resins.

The back layer may contain at least one isocyanate compound. Examples of the isocyanate composition contained in the back layer include xylene diisocyanate, toluene diisocyanate, isophorone diisocyanate, and hexamethylene diisocyanate.

The back layer may contain the above-described release material and the above-described additive.

The back layer has a thickness of, for example, 0.01 μm or more and 3.0 μm or less.

The back layer can be formed by dispersing or dissolving the above-described material in an appropriate solvent to prepare a coating liquid, applying the coating liquid onto the substrate by the above-described application means to form a coating film, and drying the coating film.

### [Combination of Thermal Transfer Sheet and Intermediate Transfer Medium]

A combination of a thermal transfer sheet and an intermediate transfer medium according to the present disclosure is a combination of the thermal transfer sheet of the present disclosure and an intermediate transfer medium. In the combination of the present disclosure, the intermediate transfer medium includes at least a substrate and a retransfer layer, and the retransfer layer includes at least a receiving layer.

In the combination of the thermal transfer sheet and the intermediate transfer medium according to the present disclosure, the “substrate”, the “peeling layer”, the “protective layer”, and the “release layer” included in the thermal transfer sheet may also be referred to as a “first substrate”, a “first peeling layer”, a “first protective layer”, and a “first release layer”, respectively. The “substrate”, a “peeling layer”, a “protective layer”, and a “release layer” included in the intermediate transfer medium may also be referred to as a “second substrate”, a “second peeling layer”, a “second protective layer”, and a “second release layer”, respectively.

The combination of the present disclosure will be described below with reference to the drawings.

In an embodiment of the present disclosure, as illustrated in FIG. 6, a combination 30 of a thermal transfer sheet and an intermediate transfer medium includes the thermal transfer sheet 10 and an intermediate transfer medium 40. The thermal transfer sheet 10 includes a first substrate 11 and the sublimation transfer discoloration- or decolorization-imparting layer 13 disposed on one surface side of the substrate 11. The intermediate transfer medium 40 includes a second substrate 41 and a retransfer layer 42 (receiving layer 43).

The intermediate transfer medium 40 may include a second release layer (not illustrated) between the second substrate 41 and the retransfer layer 42.

The retransfer layer 42 of the intermediate transfer medium 40 may include the second peeling layer (not illustrated) and the receiving layer 43, and the second peeling layer may be disposed between the second substrate 41 and the receiving layer 43.

The retransfer layer 42 of the intermediate transfer medium 40 may include a second protective layer (not illustrated) and the receiving layer 43, and the second protective layer may be disposed between the second substrate 41 and the receiving layer 43.

The retransfer layer 42 of the intermediate transfer medium 40 may include the second peeling layer, the second protective layer, and the receiving layer 43 in this order. The second peeling layer and the second protective layer may be disposed between the second substrate 41 and the receiving layer 43 (not illustrated).

The above-described layer configurations of the combination 40 can be combined as appropriate.

Each layer that can be included in the intermediate transfer medium constituting the combination of the present disclosure will be described below. The thermal transfer sheet constituting the combination of the present disclosure has been described above and will not be described here.

### <Second Substrate>

The second substrate has heat resistance to thermal energy applied during the thermal transfer of the intermediate transfer medium, mechanical strength that can support, for example, the retransfer layer disposed on the second substrate, and solvent resistance.

As the second substrate, the material used for the first substrate can be appropriately selected and used.

The second substrate has a thickness of, for example, 1 μm or more and 50 μm or less.

### <Retransfer Layer>

The retransfer layer of the combination of the present disclosure is a layer that includes at least the receiving layer. The retransfer layer is a layer to be transferred from the intermediate transfer medium by heating.

The retransfer layer of the combination of the present disclosure may include the second peeling layer between the substrate and the receiving layer.

The retransfer layer of the combination of the present disclosure may include the second protective layer between the substrate or the second peeling layer and the receiving layer.

### (Receiving Layer)

The receiving layer of the combination of the present disclosure is a layer on which a general image and/or a sublimation transfer discoloration- or decolorization-imparting image will be formed.

The receiving layer of the combination of the present disclosure may contain at least one resin material. Examples of the resin material contained in the receiving layer include polyolefins, vinyl resins, such as poly(vinyl chloride) and vinyl chloride-vinyl acetate copolymers, (meth)acrylic resins, cellulose resins, polyesters, polyamides, polycarbonates, styrene resins, epoxy resins, polyurethanes, and ionomer resins.

The receiving layer of the combination of the present disclosure preferably has a resin material content of 80% or more by mass and 99.5% or less by mass, more preferably 85% or more by mass and 99% or less by mass, based on the total component contained in the receiving layer.

The receiving layer of the combination of the present disclosure may contain the above-described additive.

The receiving layer of the combination of the present disclosure preferably has a thickness of 0.5 μm or more and 20 μm or less, more preferably 1 μm or more and 10 μm or less.

The receiving layer of the combination of the present disclosure can be formed by dispersing or dissolving the above-described material in an appropriate solvent to prepare a coating liquid, applying the coating liquid onto, for example, the second substrate, the second release layer, the second peeling layer, or the second protective layer by the above-described application means to form a coating film, and drying the coating film.

### (Second Peeling Layer)

The second peeling layer is a layer to be transferred from the intermediate transfer medium to the transfer-receiving article. The intermediate transfer medium including the second peeling layer can improve the transferability of the retransfer layer.

The second peeling layer may include at least one resin material. Examples of the resin material contained in the second peeling layer include polyesters, polyamides, polyolefins, vinyl resins, (meth)acrylic resins, imide resins, cellulose resins, styrene resins, polycarbonates, and ionomer resins.

The second peeling layer may contain the above-described release material and the above-described additive.

The second peeling layer can be formed by dispersing or dissolving the above-described material in an appropriate solvent to prepare a coating liquid, applying the coating liquid onto, for example, the second substrate by the above-described application means to form a coating film, and drying the coating film.

### (Second Protective Layer)

The intermediate transfer medium including the second protective layer can protect the image of the thermal transfer printed material.

The second protective layer may contain at least one resin material. Examples of the resin material contained in the second protective layer include polyesters, (meth)acrylic resins, epoxy resins, styrene resins, acrylic polyol resins, polyurethanes, ionizing radiation-curable resins, and ultraviolet-absorbing resins.

The second protective layer may contain the above-described additive.

The second protective layer preferably has a thickness of 0.5 μm or more and 7 μm or less, more preferably 1 μm or more and 5 μm or less. This can further improve the durability of the second protective layer.

The second protective layer can be formed by dispersing or dissolving the above-described material in an appropriate solvent to prepare a coating liquid, applying the coating liquid onto, for example, the second substrate, the second release layer, or the second peeling layer by the above-described application means to form a coating film, and drying the coating film. The intermediate transfer medium including the second release layer can improve transferability.

### <Second Release Layer>

The second release layer is a layer disposed between the second substrate and the retransfer layer and remains on the second substrate during the thermal transfer of the intermediate transfer medium.

The second release layer may contain at least one resin material. Examples of the resin material contained in the second release layer include (meth)acrylic resins, polyurethanes, acetal resins, polyamides, polyesters, melamine resins, polyol resins, cellulose resins, and silicone resins.

The second release layer may contain at least one release material. Examples of the release material include fluorine compounds, phosphate compounds, silicone oils, higher fatty acid amide compounds, metal soap, and waxes, such as paraffin wax.

The second release layer preferably has a release material content of 0.1% or more by mass and 10% or less by mass, more preferably 0.5% or more by mass and 5% or less by mass. This can further improve the transferability of the retransfer layer.

The second release layer may contain the above-described additive.

The second release layer has a thickness of, for example, 0.1 μm or more and 2.0 μm or less.

The second release layer can be formed by dispersing or dissolving the above-described material in an appropriate solvent to prepare a coating liquid, applying the coating liquid onto, for example, the second substrate by the application means to form a coating film, and drying the coating film.

### [Thermal Transfer Printed Material of First Form]

A thermal transfer printed material of a first form includes a transfer-receiving article, a general image, and a sublimation transfer discoloration- or decolorization-imparting image, in which the sublimation transfer discoloration- or decolorization-imparting image is in contact with at least part of the general image. These allow the thermal transfer printed material to be able to discolor or decolorize the image and to have a good design. Such thermal transfer printed materials are suitable for security cards and tickets, for example.

In this specification, the “thermal transfer printed material” is a printed material before the general image is discolored or decolorized by the above-described light irradiation.

The thermal transfer printed material of the first form will be described below with reference to the drawings.

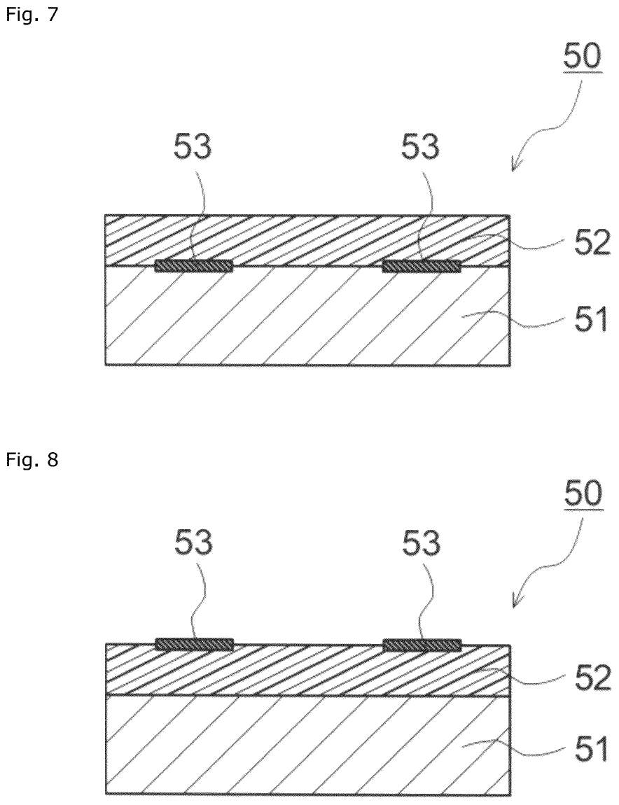

In an embodiment, as illustrated in FIG. 7, a thermal transfer printed material 50 includes a transfer-receiving article 51, a general image 52 formed by fusion transfer, and a sublimation transfer discoloration- or decolorization-imparting image 53. As illustrated in FIG. 7, the sublimation transfer discoloration- or decolorization-imparting image 53 is in contact with the general image 52 and is disposed on the transfer-receiving article 51. As illustrated in FIG. 7, the general image 52 is disposed on the transfer-receiving article 51 and the sublimation transfer discoloration or decolorization image 53.

In an embodiment, as illustrated in FIG. 8, the thermal transfer printed material 50 includes the transfer-receiving article 51, the general image 52 formed by fusion transfer, and the sublimation transfer discoloration- or decolorization-imparting image 53. As illustrated in FIG. 8, the general image 52 is disposed on the transfer-receiving article 51. As illustrated in FIG. 8, the sublimation transfer discoloration- or decolorization-imparting image 53 is in contact with the general image 52 and is disposed on the general image 52.

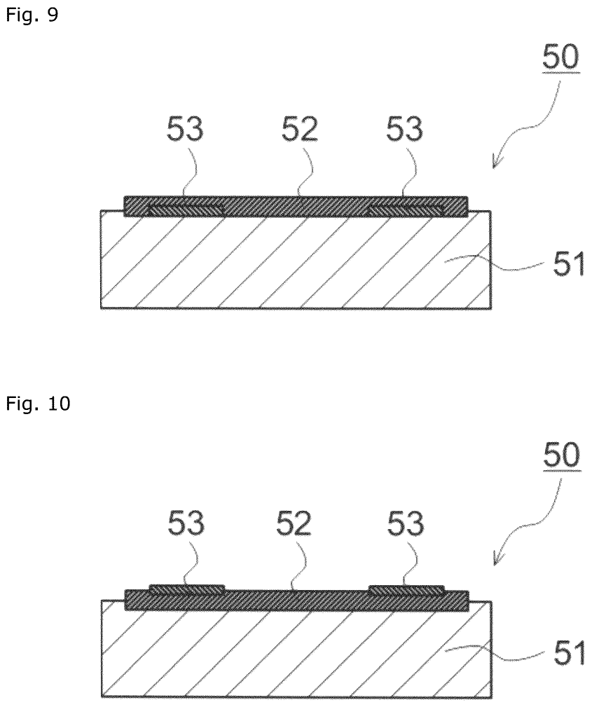

In an embodiment, as illustrated in FIG. 9, the thermal transfer printed material 50 includes the transfer-receiving article 51, the general image 52 formed by sublimation transfer, and the sublimation transfer discoloration- or decolorization-imparting image 53. As illustrated in FIG. 9, the sublimation transfer discoloration- or decolorization-imparting image 53 is in contact with the general image 52. As illustrated in FIG. 9, the general image 52 is disposed on the transfer-receiving article 51 and the sublimation transfer discoloration or decolorization image 53.

In an embodiment, as illustrated in FIG. 10, the thermal transfer printed material 50 includes the transfer-receiving article 51, the general image 52 formed by sublimation transfer, and the sublimation transfer discoloration- or decolorization-imparting image 53. As illustrated in FIG. 10, the general image 52 is disposed on the transfer-receiving article 51. As illustrated in FIG. 10, the sublimation transfer discoloration- or decolorization-imparting image 53 is in contact with the general image 52 and is disposed on the general image 52.

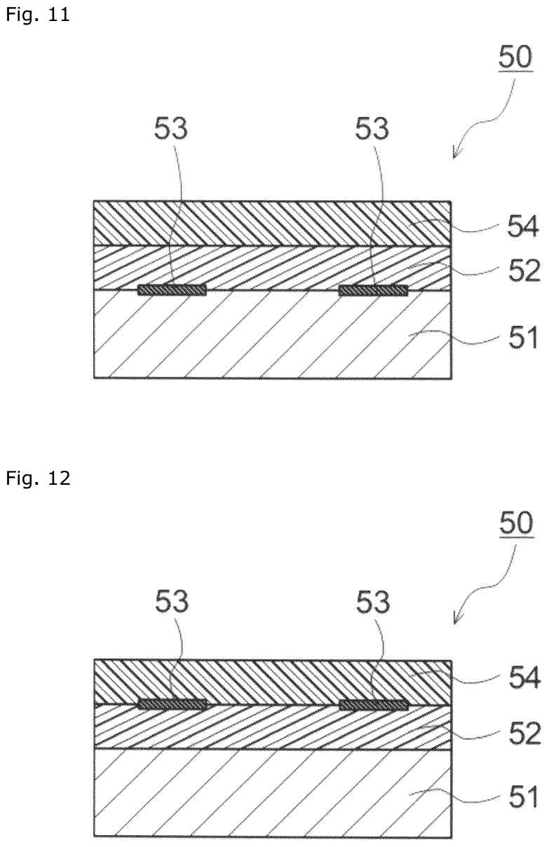

In an embodiment, as illustrated in FIG. 11, the thermal transfer printed material 50 includes the transfer-receiving article 51, the general image 52 formed by fusion transfer, the sublimation transfer discoloration- or decolorization-imparting image 53, and a protective layer 54. As illustrated in FIG. 11, the sublimation transfer discoloration- or decolorization-imparting image 53 is in contact with the general image 52 and is disposed on the transfer-receiving article 51. As illustrated in FIG. 11, the general image 52 is disposed on the transfer-receiving article 51 and the sublimation transfer discoloration or decolorization image 53. As illustrated in FIG. 11, the protective layer 54 is disposed on the general image 52.

In an embodiment, as illustrated in FIG. 12, the thermal transfer printed material 50 includes the transfer-receiving article 51, the general image 52 formed by fusion transfer, the sublimation transfer discoloration- or decolorization-imparting image 53, and the protective layer 54. As illustrated in FIG. 12, the general image 52 is disposed on the transfer-receiving article 51. As illustrated in FIG. 12, the sublimation transfer discoloration- or decolorization-imparting image 53 is in contact with the general image 52 and is disposed on the general image 52. As illustrated in FIG. 12, the protective layer 54 is disposed on the general image 52 and the sublimation transfer discoloration- or decolorization-imparting image 53.

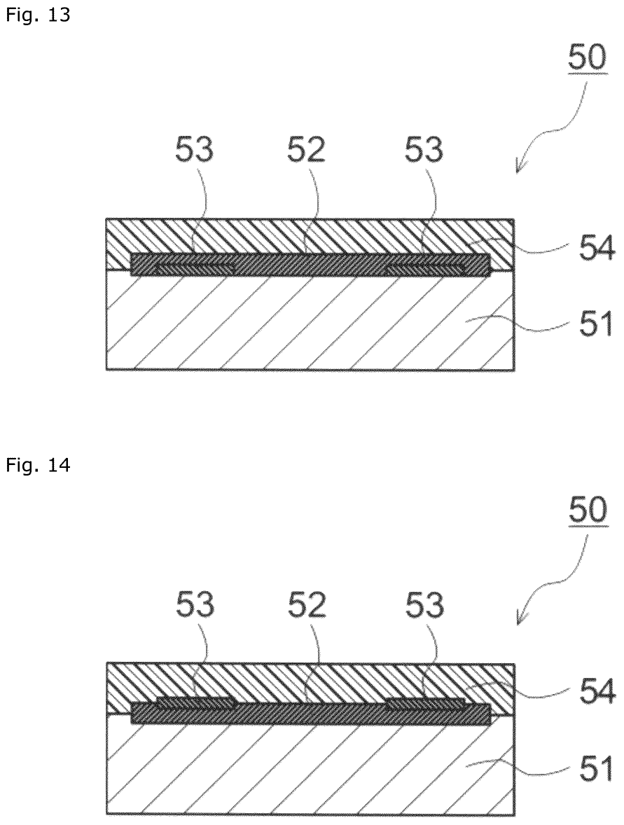

In an embodiment, as illustrated in FIG. 13, the thermal transfer printed material 50 includes the transfer-receiving article 51, the general image 52 formed by sublimation transfer, the sublimation transfer discoloration- or decolorization-imparting image 53, and the protective layer 54. As illustrated in FIG. 13, the sublimation transfer discoloration- or decolorization-imparting image 53 is in contact with the general image 52 and is disposed on the transfer-receiving article 51. As illustrated in FIG. 13, the general image 52 is disposed on the transfer-receiving article 51 and the sublimation transfer discoloration or decolorization image 53. As illustrated in FIG. 13, the protective layer 54 is disposed on the general image 52.

In an embodiment, as illustrated in FIG. 14, the thermal transfer printed material 50 includes the transfer-receiving article 51, the general image 52 formed by sublimation transfer, the sublimation transfer discoloration- or decolorization-imparting image 53, and the protective layer 54. As illustrated in FIG. 14, the general image 52 is disposed on the transfer-receiving article 51. As illustrated in FIG. 14, the sublimation transfer discoloration- or decolorization-imparting image 53 is in contact with the general image 52 and is disposed on the general image 52. As illustrated in FIG. 12, the protective layer 54 is disposed on the general image 52 and the sublimation transfer discoloration- or decolorization-imparting image 53.

The above-described layer configurations of the thermal transfer printed material 50 can be combined as appropriate.

The thermal transfer printed material of the first form can be produced by using the thermal transfer sheet of the present disclosure.

Each layer that can be included in the thermal transfer printed material of the first form will be described below.

### <Transfer-Receiving Article>

The transfer-receiving article included in the thermal transfer printed material is not particularly limited. Examples of the transfer-receiving article include paper substrates, such as woodfree paper, art paper, coated paper, resin-coated paper, cast coated paper, paper board, synthetic paper, and impregnated paper, resin films described below, laminates thereof, and cards.

The transfer-receiving article has a thickness of, for example, 0.1 mm or more and 2 mm or less.

### <Sublimation Transfer Discoloration- or Decolorization-Imparting Image>

The sublimation transfer discoloration- or decolorization-imparting image of the thermal transfer printed material of the first form is an image formed by sublimation or diffusion of the compound responsible for discoloration or decolorization. Thereby, the thermal transfer printed material has a surface with suppressed unevenness and a good design.

The sublimation transfer discoloration- or decolorization-imparting image of the thermal transfer printed material of the first form is in contact with at least part of the general image and contains the compound responsible for discoloration or decolorization. The sublimation transfer discoloration- or decolorization-imparting image may be a colored image or a colorless, transparent image, and is preferably a colorless, transparent image.

The sublimation transfer discoloration- or decolorization-imparting image of the thermal transfer printed material of the first form may be disposed in whole or in part in the plane direction of the thermal transfer printed material. The sublimation transfer discoloration- or decolorization-imparting image may be disposed in whole or in part on the general image and/or on the transfer-receiving article.

The sublimation transfer discoloration- or decolorization-imparting image of the thermal transfer printed material of the first form can be formed from the sublimation transfer discoloration- or decolorization-imparting layer of the thermal transfer sheet of the present disclosure.

### <General Image>

Examples of the general image of the thermal transfer printed material of the first form include photographs, characters, patterns, symbols, and combinations thereof. The general image contains the above-described coloring material.

The general image of the thermal transfer printed material of the first form may be disposed in whole or in part in the plane direction of the thermal transfer printed material. The general image may be disposed in whole or in part on the sublimation transfer discoloration- or decolorization-imparting image and/or on the transfer-receiving article.

The general image of the thermal transfer printed material of the first form can be formed from the coloring material layer of the thermal transfer sheet of the present disclosure.

The general image of the thermal transfer printed material of the first form can be formed from the coloring material layer of a thermal transfer sheet different from the thermal transfer sheet of the present disclosure.

The general image of the thermal transfer printed material of the first form can be formed from a coloring material-containing ink by an ink-jet method.

### <Protective Layer>

The protective layer of the thermal transfer printed material of the first form is a layer to protect the image of the thermal transfer printed material.

The protective layer may be disposed on the opposite side of the general image and/or the sublimation transfer discoloration- or decolorization-imparting image from the transfer-receiving article. The protective layer may be disposed at the outermost surface of the thermal transfer printed material.

The protective layer of the thermal transfer printed material of the first form may contain at least one resin material. Examples of the resin material contained in the protective layer include (meth)acrylic resins, polyesters, cellulose resins, styrene resins, polyamides, polyolefins, vinyl resins, imide resins, polycarbonates, ionomer resins, silicone resins, hydroxy group-containing resins, thermosetting resins, and actinic radiation-curable resins.

The protective layer of the thermal transfer printed material of the first form may contain the above-described additive. The protective layer of the thermal transfer printed material of the first form may contain the above-described release material.

The protective layer of the thermal transfer printed material of the first form has a resin material content of, for example, 50% or more by mass and 90% or less by mass.

In an embodiment, the protective layer of the thermal transfer printed material of the first form has a thickness of, for example, 0.1 μm or more and 13 μm or less. In an embodiment, the protective layer of the thermal transfer printed material of the first form may be formed of a single layer or multiple layers.

The protective layer of the thermal transfer printed material of the first form can be formed from the protective layer and/or the peeling layer of the thermal transfer sheet of the present disclosure.

### [Method for Producing Thermal Transfer Printed Material of First Form]

A method for producing the thermal transfer printed material of the first form includes the steps of providing the thermal transfer sheet of the present disclosure and a transfer-receiving article and forming a general image and a sublimation transfer discoloration- or decolorization-imparting image on the transfer-receiving article in such a manner that the general image and the sublimation transfer discoloration- or decolorization-imparting image are in contact with each other. The sublimation transfer discoloration- or decolorization-imparting image is formed from the sublimation transfer discoloration- or decolorization-imparting layer of the thermal transfer sheet of the present disclosure.

Each step included in the method for producing the thermal transfer printed material of the first form will be described below.

### <Step of Providing Thermal Transfer Sheet and Transfer-Receiving Article>

The method for producing the thermal transfer printed material of the first form includes the steps of providing the thermal transfer sheet of the present disclosure and the transfer-receiving article. Since the method for producing the thermal transfer sheet is as described above, the description thereof is omitted here.

Examples of the transfer-receiving article include those described above. The transfer-receiving article may be a commercially available product or may be produced by a method, such as a T-die method or an inflation method.

### <Step of Forming General Image and Sublimation Transfer Discoloration- or Decolorization-Imparting Image>

The method for producing the thermal transfer printed material of the first form includes the step of forming the general image and the sublimation transfer discoloration- or decolorization-imparting image on the transfer-receiving article in such a manner that the general image and the sublimation transfer discoloration- or decolorization-imparting image are in contact with each other. In the image formation step, the sublimation transfer discoloration- or decolorization-imparting image is formed from the sublimation transfer discoloration- or decolorization-imparting layer of the thermal transfer sheet of the present disclosure.

In one embodiment, the image formation step is a step of forming the general image on the transfer-receiving article and then forming the sublimation transfer discoloration- or decolorization-imparting image on the general image.

In one embodiment, the image formation step is a step of forming the sublimation transfer discoloration- or decolorization-imparting image on the transfer-receiving article and then forming the general image on the sublimation transfer discoloration- or decolorization-imparting image.

The general image may be formed using the thermal transfer sheet of the present disclosure or may be formed using a thermal transfer sheet different from the thermal transfer sheet of the present disclosure. The general image may be formed from the coloring material layer included in the thermal transfer sheet of the present disclosure or may be separately formed from, for example, a thermal transfer sheet including a coloring material layer.

The general image may be formed by sublimation transfer or fusion transfer.

The general image may be formed by an ink-jet method using a coloring material-containing ink.

The general image and the sublimation transfer discoloration- or decolorization-imparting image can be formed by a conventionally known method with, for example, a commercially available thermal transfer printer or an ink-jet printer.

### [Discolored or Decolorized Printed Material of First Form]

The discolored or decolorized printed material of the first form includes a transfer-receiving article and a discolored or decolorized portion.

In this specification, the “discolored or decolorized printed material” is a printed material after the general image has been discolored or decolorized by the above-described light irradiation.

In one embodiment, the discolored or decolorized portion of the discolored or decolorized printed material of the first form contains a reaction product of a coloring material and a compound responsible for discoloration or decolorization.

The discolored or decolorized printed material of the first form will be described below with reference to the drawings.

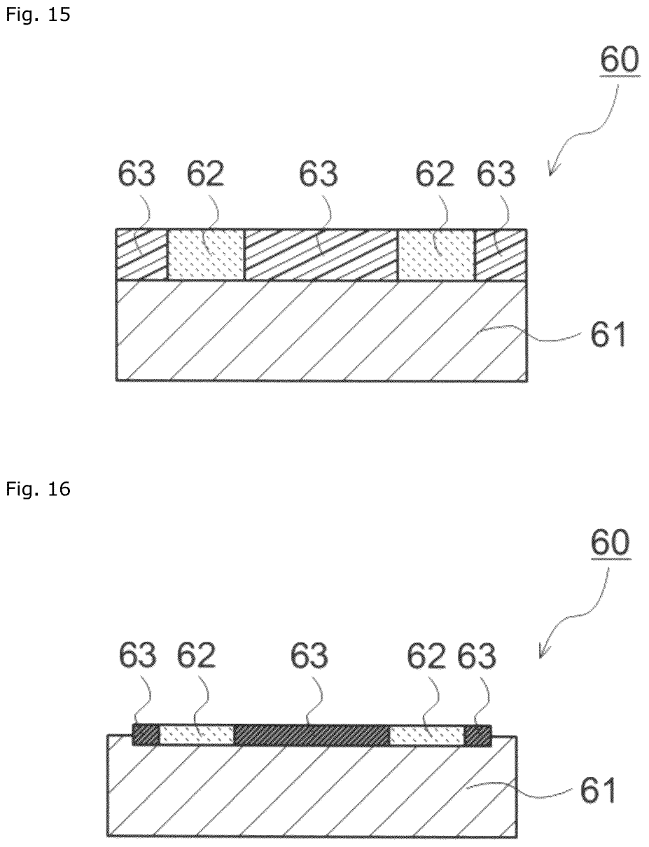

In an embodiment, as illustrated in FIG. 15, a discolored or decolorized printed material 60 includes a transfer-receiving article 61, a discolored or decolorized portion 62, and a general image 63 formed by fusion transfer. The discolored or decolorized portion 62 and the general image 63 are formed on the transfer-receiving article 61.

In an embodiment, as illustrated in FIG. 16, the discolored or decolorized printed material 60 includes the transfer-receiving article 61, the discolored or decolorized portion 62, and the general image 63 formed by sublimation transfer. The discolored or decolorized portion 62 and the general image 63 are disposed on the transfer-receiving article 61.

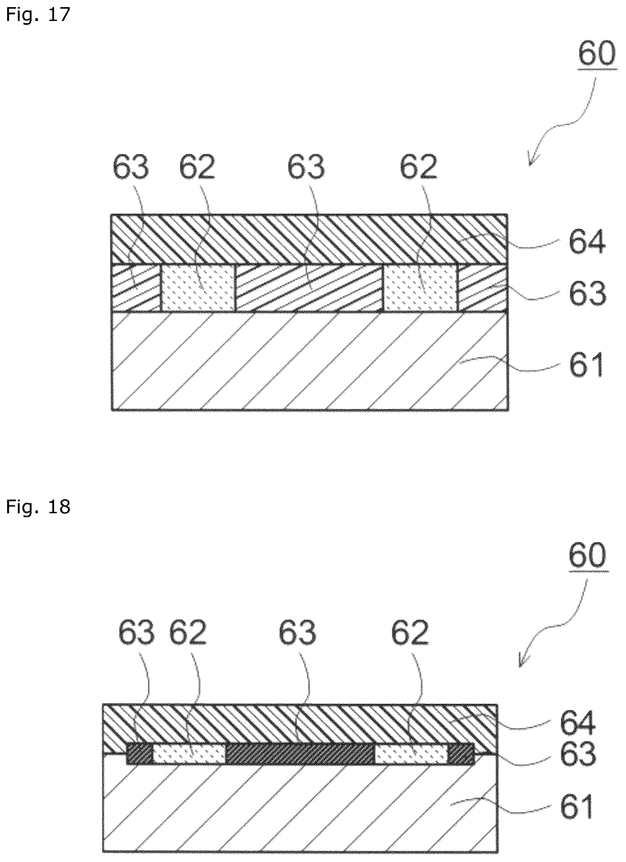

In an embodiment, as illustrated in FIG. 17, the discolored or decolorized printed material 60 includes the transfer-receiving article 61, the discolored or decolorized portion 62, the general image 63 formed by fusion transfer, and a protective layer 64. As illustrated in FIG. 17, the discolored or decolorized portion 62 and the general image 63 are disposed on the transfer-receiving article 61. As illustrated in FIG. 17, the protective layer 64 is disposed on the discolored or decolorized portion 62 and the general image 63.

In an embodiment, as illustrated in FIG. 18, the discolored or decolorized printed material 60 includes the transfer-receiving article 61, the discolored or decolorized portion 62, the general image 63 formed by sublimation transfer, and the protective layer 64. As illustrated in FIG. 18, the discolored or decolorized portion 62 and the general image 63 are disposed on the transfer-receiving article 61. As illustrated in FIG. 18, the protective layer 64 is disposed on the discolored or decolorized portion 62 and the general image 63.

The discolored or decolorized printed material 60 may include a sublimation transfer discoloration- or decolorization-imparting image (not illustrated) between the transfer-receiving article 61 and the general image 63 and/or on the opposite side of the general image 63 from the transfer-receiving article 61.

The above-described layer configurations of the discolored or decolorized printed material 60 can be combined as appropriate.

The discolored or decolorized printed material of the first form can be produced using the thermal transfer printed material of the first form.

Each layer that can be included in the discolored or decolorized printed material of the first form will be described below.

### <Transfer-Receiving Article>

As the transfer-receiving article of the discolored or decolorized printed material of the first form, the transfer-receiving article described in the thermal transfer printed material of the first form can be used.

A discolored or decolorized transfer layer can be formed from the transfer layer of the thermal transfer printed material of the first form.

### <Discolored or Decolorized Portion>

The discolored or decolorized portion is a portion where the general image has been discolored or decolorized by the above-described light irradiation.

In an embodiment, the discolored or decolorized portion contains the reaction product of the coloring material contained in the general image and the compound responsible for discoloration or decolorization contained in the sublimation transfer discoloration- or decolorization-imparting image. Examples of the reaction product include the reaction product of the coloring material and the compound responsible for discoloration or decolorization by the above-described light irradiation or the above-described heat treatment; and/or products obtained by initiation of the reaction of the coloring material due to the compound responsible for discoloration or decolorization and then decomposition, breakdown, or polymerization of the coloring material.

### <Sublimation Transfer Discoloration- or Decolorization-Imparting Image>

The sublimation transfer discoloration- or decolorization-imparting image of the discolored or decolorized transfer layer contains the compound responsible for discoloration or decolorization, the compound having sublimability or diffusibility. The compound responsible for discoloration or decolorization contained in the sublimation transfer discoloration- or decolorization-imparting image is, for example, an unreacted component that did not react with the coloring material by the above-described light irradiation.

The sublimation transfer discoloration- or decolorization-imparting image of the discolored or decolorized printed material of the first form may be disposed on the general image and/or the transfer-receiving article.

The sublimation transfer discoloration- or decolorization-imparting image of the discolored or decolorized printed material of the first form can be formed from the sublimation transfer discoloration- or decolorization-imparting image of the thermal transfer printed material of the first form.

### <General Image>

Examples of the general image of the discolored or decolorized transfer layer include photographs, characters, patterns, symbols, and combinations thereof. The general image of the discolored or decolorized transfer layer contains the above-described coloring material. The coloring material contained in the general image is, for example, an unreacted component that did not react with the compound responsible for discoloration or decolorization by the above-described light irradiation.

The general image of the discolored or decolorized printed material of the first form may be disposed on the sublimation transfer discoloration- or decolorization-imparting image and/or the transfer-receiving article.

The general image of the discolored or decolorized printed material of the first form can be formed from the general image of the thermal transfer printed material of the first form.

### <Protective Layer>

The protective layer of the discolored or decolorized printed material of the first form may be disposed on the opposite side of the discolored or decolorized portion from the transfer-receiving article. The protective layer may be disposed at the outermost surface of the discolored or decolorized printed material.

As the protective layer of the discolored or decolorized printed material of the first form, the protective layer described in the thermal transfer printed material of the first form can be used.

### [Method for Producing Discolored or Decolorized Printed Material of First Form]

A method for producing the discolored or decolorized printed material of the first form includes a step of providing the thermal transfer printed material of the first form, and a light irradiation step of performing irradiation with a light beam having a predetermined intensity for a predetermined period of time from a side of the thermal transfer printed material of the first form adjacent to the general image and the sublimation transfer discoloration- or decolorization-imparting image to discolor or decolorize the general image.

Each step included in the method for producing the discolored or decolorized printed material of the first form will be described below.

### <Step of Providing Thermal Transfer Printed Material>

The method for producing the discolored or decolorized printed material of the first form includes the step of providing the thermal transfer printed material of the first form. Since the method for producing the thermal transfer printed material is as described above, the description thereof is omitted here.

### <Light Irradiation Step>

In an embodiment, the method for producing the discolored or decolorized printed material of the first form includes the light irradiation step of performing irradiation with the light beam having a predetermined intensity for a predetermined period of time from the side of the thermal transfer printed material of the first form to discolor or decolorize the general image. The irradiation with the light beam with a predetermined intensity for a predetermined period of time is, for example, irradiation with a xenon lamp at an irradiation intensity of 0.1 W/m² or more for 0.1 seconds or more.

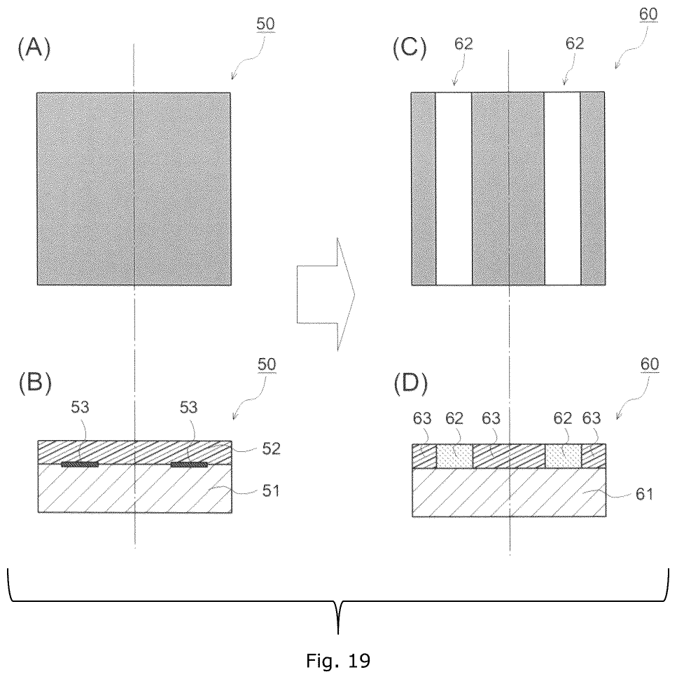

As illustrated in FIG. 19, when the thermal transfer printed material 50 is irradiated with light, part of the general image 53 is discolored or decolorized to form the discolored or decolorized portion 62. Thereby, the discolored or decolorized printed material 60 can be produced. In FIG. 19, (A) is a plan view of the thermal transfer printed material 50, (B) is a cross-sectional view of the thermal transfer printed material 50, (C) is a plan view of the discolored or decolorized printed material 60, and (D) is a cross-sectional view of the discolored or decolorized printed material 60.

The light irradiation intensity is preferably 0.1 W/m² or more and 5 W/m² or less, more preferably 0.1 W/m² or more and 3 W/m² or less. Thereby, the discolored or decolorized portion can be satisfactorily formed.

The light irradiation time is preferably 0.1 seconds or more and 2,160 hours or less, more preferably 1 second or more and 720 hours or less, even more preferably 1 hour or more and 240 hours or less. Thereby, the discolored or decolorized portion can be satisfactorily formed.

### [Thermal Transfer Printed Material of Second Form]

A thermal transfer printed material of a second form includes a transfer-receiving article and a retransfer layer, in which the retransfer layer includes at least a receiving layer, a general image, and a sublimation transfer discoloration- or decolorization-imparting image. In the thermal transfer printed material of the second form, the sublimation transfer discoloration- or decolorization-imparting image is in contact with at least part of the general image. These allow the thermal transfer printed material to be able to discolor or decolorize the general image. Such thermal transfer printed materials are suitable for security cards and tickets, for example.

The thermal transfer printed material of the second form will be described below with reference to the drawings.

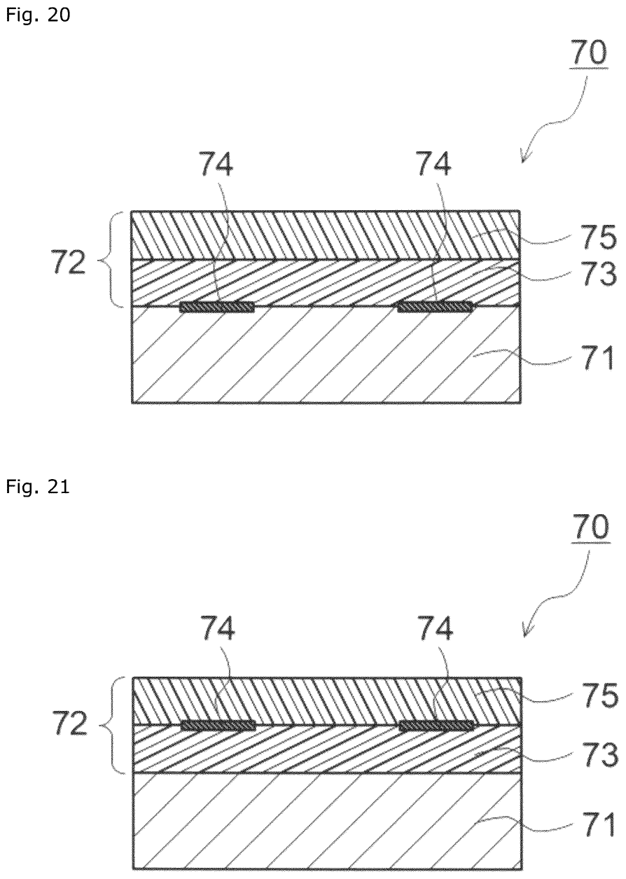

In an embodiment, as illustrated in FIG. 20, a thermal transfer printed material 70 includes a transfer-receiving article 71, and a retransfer layer 72, in which the retransfer layer 72 includes a general image 73 formed by fusion transfer, a sublimation transfer discoloration- or decolorization-imparting image 74, and a receiving layer 75. As illustrated in FIG. 20, the sublimation transfer discoloration- or decolorization-imparting image 74 is in contact with the general image 73. As illustrated in FIG. 20, the receiving layer 75 is disposed on the opposite side of the general image 73 from the transfer-receiving article 71.

In an embodiment, as illustrated in FIG. 21, the thermal transfer printed material 70 includes the transfer-receiving article 71 and the retransfer layer 72, in which the retransfer layer 72 includes the general image 73 formed by fusion transfer, the sublimation transfer discoloration- or decolorization-imparting image 74, and the receiving layer 75. As illustrated in FIG. 21, the sublimation transfer discoloration- or decolorization-imparting image 74 is in contact with the general image 73 and disposed on the opposite side of the general image 73 from the transfer-receiving article 71. As illustrated in FIG. 21, the receiving layer 75 is disposed on the opposite side of the general image 73 from the transfer-receiving article 71.

In an embodiment, as illustrated in FIG. 22, the thermal transfer printed material 70 includes the transfer-receiving article 71 and the retransfer layer 72, in which the retransfer layer 72 includes the general image 73 formed by sublimation transfer, the sublimation transfer discoloration- or decolorization-imparting image 74, and the receiving layer 75. As illustrated in FIG. 22, the sublimation transfer discoloration- or decolorization-imparting image 74 is in contact with the general image 73. As illustrated in FIG. 22, the general image 73 and the sublimation transfer discoloration- or decolorization-imparting image 74 are disposed on the receiving layer 75.

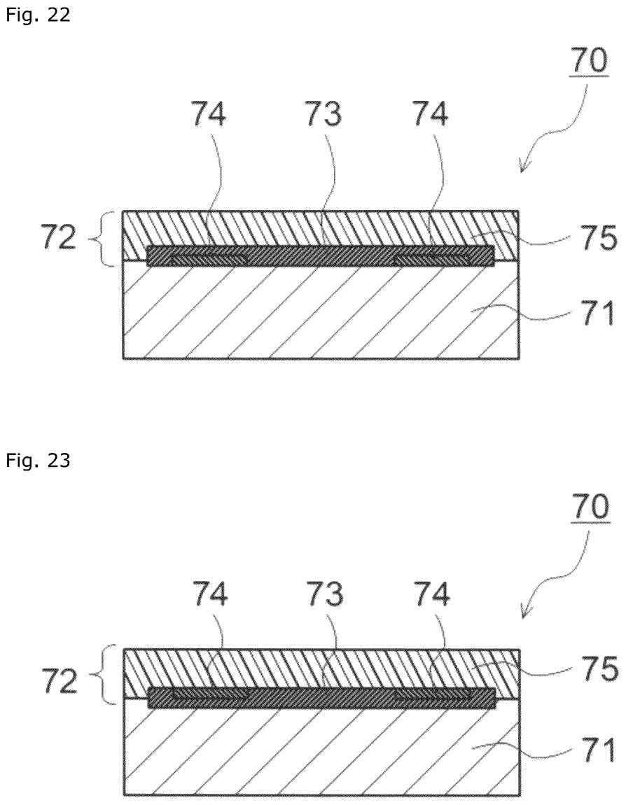

In an embodiment, as illustrated in FIG. 23, the thermal transfer printed material 70 includes the transfer-receiving article 71 and the retransfer layer 72, in which the retransfer layer 72 includes the general image 73 formed by sublimation transfer, the sublimation transfer discoloration- or decolorization-imparting image 74, and the receiving layer 75. As illustrated in FIG. 23, the sublimation transfer discoloration- or decolorization-imparting image 74 is in contact with the general image 73 and disposed on the opposite side of the general image 73 from the transfer-receiving article 71. As illustrated in FIG. 23, as illustrated in FIG. 23, the general image 73 and the sublimation transfer discoloration- or decolorization-imparting image 74 are disposed on the receiving layer 75.

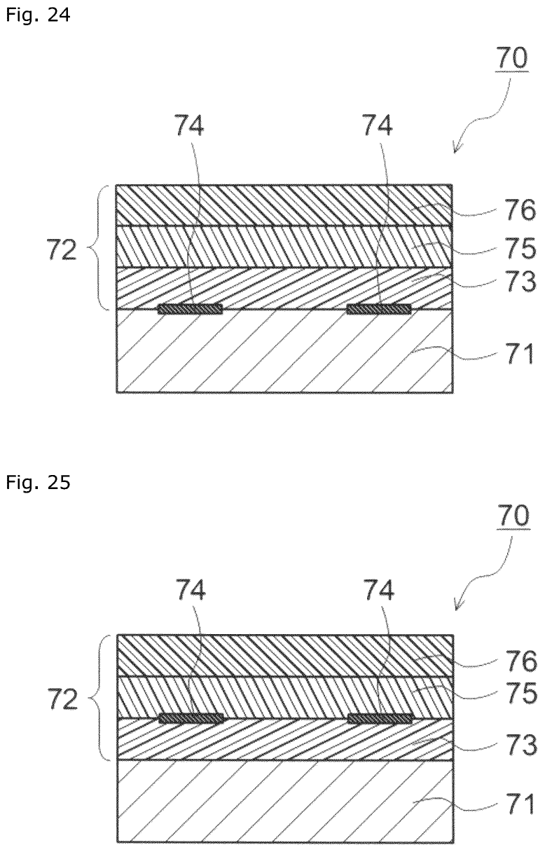

In an embodiment, as illustrated in FIG. 24, the thermal transfer printed material 70 includes the transfer-receiving article 71 and the retransfer layer 72, in which the retransfer layer 72 includes the general image 73 formed by fusion transfer, the sublimation transfer discoloration- or decolorization-imparting image 74, the receiving layer 75, and a protective layer 76. As illustrated in FIG. 24, the sublimation transfer discoloration- or decolorization-imparting image 74 is in contact with the general image 73. As illustrated in FIG. 24, the receiving layer 75 is disposed on the opposite side of the general image 73 from the transfer-receiving article 71. As illustrated in FIG. 24, the protective layer 76 is disposed on the opposite side of the receiving layer 75 from the general image 73.

In an embodiment, as illustrated in FIG. 25, the thermal transfer printed material 70 includes the transfer-receiving article 71 and the retransfer layer 72, in which the retransfer layer 72 includes the general image 73 formed by fusion transfer, the sublimation transfer discoloration- or decolorization-imparting image 74, the receiving layer 75, and the protective layer 76. As illustrated in FIG. 25, the sublimation transfer discoloration- or decolorization-imparting image 74 is in contact with the general image 73 and disposed on the opposite side of the general image 73 from the transfer-receiving article 71. As illustrated in FIG. 25, the receiving layer 75 is disposed on the opposite side of the general image 73 from the transfer-receiving article 71. As illustrated in FIG. 25, the protective layer 76 is disposed on the opposite side of the receiving layer 75 from the general image 73.

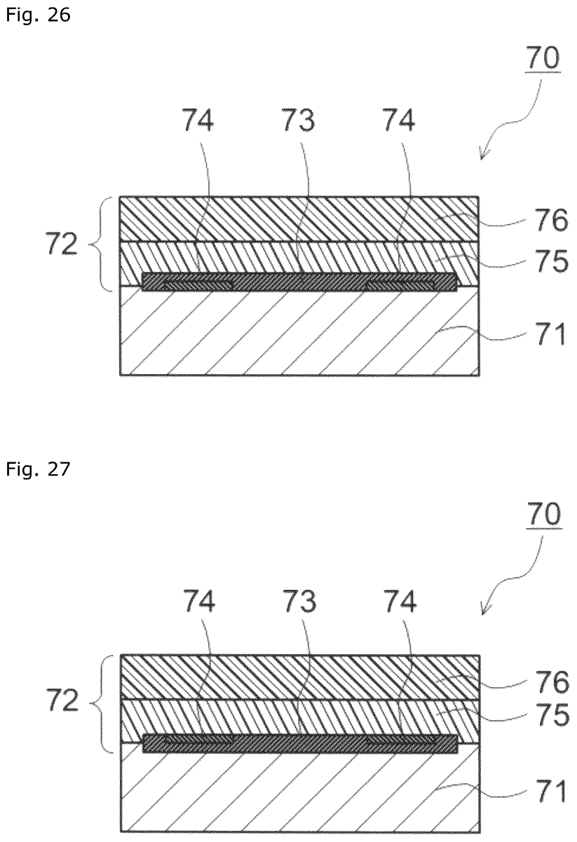

In an embodiment, as illustrated in FIG. 26, the thermal transfer printed material 70 includes the transfer-receiving article 71 and the retransfer layer 72, in which the retransfer layer 72 includes the general image 73 formed by sublimation transfer, the sublimation transfer discoloration- or decolorization-imparting image 74, the receiving layer 75, and the protective layer 76. As illustrated in FIG. 26, the sublimation transfer discoloration- or decolorization-imparting image 74 is in contact with the general image 73. As illustrated in FIG. 26, the receiving layer 75 is disposed on the opposite side of the general image 73 from the transfer-receiving article 71. As illustrated in FIG. 26, the protective layer 76 is disposed on the opposite side of the receiving layer 75 from the general image 73. As illustrated in FIG. 26, the general image 73 and the sublimation transfer discoloration- or decolorization-imparting image 74 are disposed on the receiving layer 75.

In an embodiment, as illustrated in FIG. 27, the thermal transfer printed material 70 includes the transfer-receiving article 71 and the retransfer layer 72, in which the retransfer layer 72 includes the general image 73 formed by sublimation transfer, the sublimation transfer discoloration- or decolorization-imparting image 74, the receiving layer 75, and the protective layer 76. As illustrated in FIG. 27, the sublimation transfer discoloration- or decolorization-imparting image 74 is in contact with the general image 73 and disposed on the opposite side of the general image 73 from the transfer-receiving article 71. As illustrated in FIG. 27, the receiving layer 75 is disposed on the opposite side of the general image 73 from the transfer-receiving article 71. As illustrated in FIG. 27, the protective layer 76 is disposed on the opposite side of the receiving layer 75 from the general image 73. As illustrated in FIG. 27, the general image 73 and the sublimation transfer discoloration- or decolorization-imparting image 74 are disposed on the receiving layer 75.

The above-described layer configurations of the thermal transfer printed material 70 can be combined as appropriate.

The thermal transfer printed material of the second form can be produced using the combination of the thermal transfer sheet and the intermediate transfer medium according to the present disclosure.

Each layer that can be included in the thermal transfer printed material of the second form will be described below.

### <Transfer-Receiving Article>

As the transfer-receiving article of the thermal transfer printed material of the second form, the transfer-receiving article described in the thermal transfer printed material of the first form can be used.

### <Retransfer Layer>

The transfer layer of the thermal transfer printed material is a layer including at least a receiving layer, a general image, and a sublimation transfer discoloration- or decolorization-imparting image. The receiving layer may be disposed on the opposite side of the general image from the transfer-receiving article.

The transfer layer of the thermal transfer printed material may include a protective layer on the opposite side of the receiving layer from the general image and/or the sublimation transfer discoloration- or decolorization-imparting image. The protective layer may be disposed at the outermost surface of the thermal transfer printed material.

The retransfer layer of the thermal transfer printed material can be formed from the retransfer layer of the combination of the thermal transfer sheet and the intermediate transfer medium according to the present disclosure.

### (Receiving Layer)

The receiving layer of the thermal transfer printed material is a layer on which the general image and/or the sublimation transfer discoloration- or decolorization-imparting image has been formed.

The receiving layer of the thermal transfer printed material may contain at least one resin material. Examples of the resin material contained in the receiving layer include polyolefins, vinyl resins, such as poly(vinyl chloride) and vinyl chloride-vinyl acetate copolymers, (meth)acrylic resins, cellulose resins, polyesters, polyamides, polycarbonates, styrene resins, epoxy resins, polyurethanes, and ionomer resins.

The receiving layer of the thermal transfer printed material preferably has a resin material content of 80% or more by mass and 99.5% or less by mass, more preferably 85% or more by mass and 99% or less by mass, based on the total component contained in the receiving layer.

The receiving layer of the thermal transfer printed material may contain the above-described additive.

The receiving layer of the thermal transfer printed material preferably has a thickness of 0.5 μm or more and 20 μm or less, more preferably 1 μm or more and 10 μm or less.

The receiving layer of the thermal transfer printed material can be formed from the receiving layer of the intermediate transfer medium of the combination of the thermal transfer sheet and the intermediate transfer medium according to the present disclosure.

### (Sublimation Transfer Discoloration- or Decolorization-Imparting Image)

The sublimation transfer discoloration- or decolorization-imparting image of the thermal transfer printed material of the second form is an image formed by sublimation or diffusion of the compound responsible for discoloration or decolorization. Thereby, the thermal transfer printed material has a surface with suppressed unevenness and a good design.

The sublimation transfer discoloration- or decolorization-imparting image of the thermal transfer printed material of the second form is in contact with at least part of the general image and contains the compound responsible for discoloration or decolorization. The sublimation transfer discoloration- or decolorization-imparting image may be a colored image or a colorless, transparent image, and is preferably a colorless, transparent image.

The sublimation transfer discoloration- or decolorization-imparting image of the thermal transfer printed material of the second form may be disposed in whole or in part in the plane direction of the thermal transfer printed material. The sublimation transfer discoloration- or decolorization-imparting image may be disposed in whole or in part on the general image and/or on the receiving layer.

The sublimation transfer discoloration- or decolorization-imparting image of the thermal transfer printed material of the second form can be formed from the sublimation transfer discoloration- or decolorization-imparting layer of the intermediate transfer medium of the combination of the thermal transfer sheet and the intermediate transfer medium according to the present disclosure.

### (General Image)

Examples of the general image of the thermal transfer printed material of the second form include photographs, characters, patterns, symbols, and combinations thereof. The general image contains the above-described coloring material.

The general image of the thermal transfer printed material of the second form may be disposed in whole or in part in the plane direction of the thermal transfer printed material. The general image may be disposed in whole or in part on the sublimation transfer discoloration- or decolorization-imparting image and/or the receiving layer.

The general image of the thermal transfer printed material of the second form can be formed from the coloring material layer of the thermal transfer sheet of the combination of the thermal transfer sheet and the intermediate transfer medium according to the present disclosure.

The general image of the thermal transfer printed material of the second form can be formed from the coloring material layer of a thermal transfer sheet of a combination different from the combination of the thermal transfer sheet and the intermediate transfer medium according to the present disclosure.

The general image of the thermal transfer printed material of the second form can be formed from a coloring material-containing ink by an ink-jet method.

### (Protective Layer)

As the protective layer of the thermal transfer printed material of the second form, the protective layer described in the thermal transfer printed material of the first form can be used.

[Method for producing Thermal Transfer Printed Material of Second Form]

In an embodiment, a method for producing the thermal transfer printed material of the second form includes the steps of providing the combination of the thermal transfer sheet and the intermediate transfer medium according to the present disclosure and the transfer-receiving article, forming the general image and the sublimation transfer discoloration- or decolorization-imparting image on the receiving layer of the intermediate transfer medium in such a manner that the general image and the sublimation transfer discoloration- or decolorization-imparting image are in contact with each other, and transferring the retransfer layer including at least the receiving layer, the general image, and the sublimation transfer discoloration- or decolorization-imparting image to the transfer-receiving article. The general image is formed from the coloring material layer of the thermal transfer sheet of the combination of the present disclosure, and the sublimation transfer discoloration- or decolorization-imparting image is formed from the sublimation transfer discoloration- or decolorization-imparting layer of the thermal transfer sheet of the combination of the present disclosure.

Each step included in the method for producing the thermal transfer printed material of the second form will be described below.

### <Step of Providing Combination of Thermal Transfer Sheet and Intermediate Transfer Medium and Transfer-Receiving Article>

In an embodiment, the method for producing the thermal transfer printed material of the second form includes the steps of providing the combination of the thermal transfer sheet and the intermediate transfer medium according to the present disclosure and the transfer-receiving article. Methods of producing the thermal transfer sheet and the intermediate transfer medium in the combination have been described above; thus, the description thereof is omitted here.

Examples of the transfer-receiving article include those described above. The transfer-receiving article may be a commercially available product or may be produced by a method, such as a T die method or an inflation method.

### <Step of Forming General Image and Sublimation Transfer Discoloration- or Decolorization-Imparting Image>

In an embodiment, the method for producing the thermal transfer printed material of the second form includes the step of forming the general image and the sublimation transfer discoloration- or decolorization-imparting image on the receiving layer of the intermediate transfer medium in such a manner that the general image and the sublimation transfer discoloration- or decolorization-imparting image are in contact with each other. In the image formation step, the sublimation transfer discoloration- or decolorization-imparting image is formed from the sublimation transfer discoloration- or decolorization-imparting layer of the thermal transfer sheet of the combination of the present disclosure.

In an embodiment, the image formation step is a step of forming the general image on the receiving layer of the intermediate transfer medium, and then forming the sublimation transfer discoloration- or decolorization-imparting image on the general image.

In an embodiment, the image formation step is a step of forming the sublimation transfer discoloration- or decolorization-imparting image on the receiving layer of the intermediate transfer medium, and then forming the general image on the sublimation transfer discoloration- or decolorization-imparting image.

The general image may be formed using the thermal transfer sheet of the combination of the present disclosure, or may be formed using a thermal transfer sheet different from the thermal transfer sheet of the combination of the present disclosure. The general image may be formed from the coloring material layer included in the thermal transfer sheet of the combination of the present disclosure, or may be separately formed from, for example, a thermal transfer sheet including a coloring material layer.

The formation of the general image may be performed by sublimation transfer or fusion transfer.

The general image may be formed by an ink-jet method using a coloring material-containing ink.

The general image and the sublimation transfer discoloration- or decolorization-imparting image can be formed by a conventionally known method with, for example, a commercially available thermal transfer printer or an ink-jet printer.

### <Step of Transferring Retransfer Layer>

In an embodiment, the method for producing the thermal transfer printed material of the second form includes the step of transferring the retransfer layer including at least the receiving layer, the general image, and the sublimation transfer discoloration- or decolorization-imparting image to the transfer-receiving article.

The transfer can be performed by a conventionally known method with, for example, a commercially available thermal transfer printer.

### [Discolored or Decolorized Printed Material of Second Form]

A discolored or decolorized printed material of a second form includes a transfer-receiving article and a discolored or decolorized retransfer layer, in which the discolored or decolorized retransfer layer includes at least a receiving layer and a discolored or decolorized portion.

The discolored or decolorized printed material of the second form will be described below with reference to the drawings.

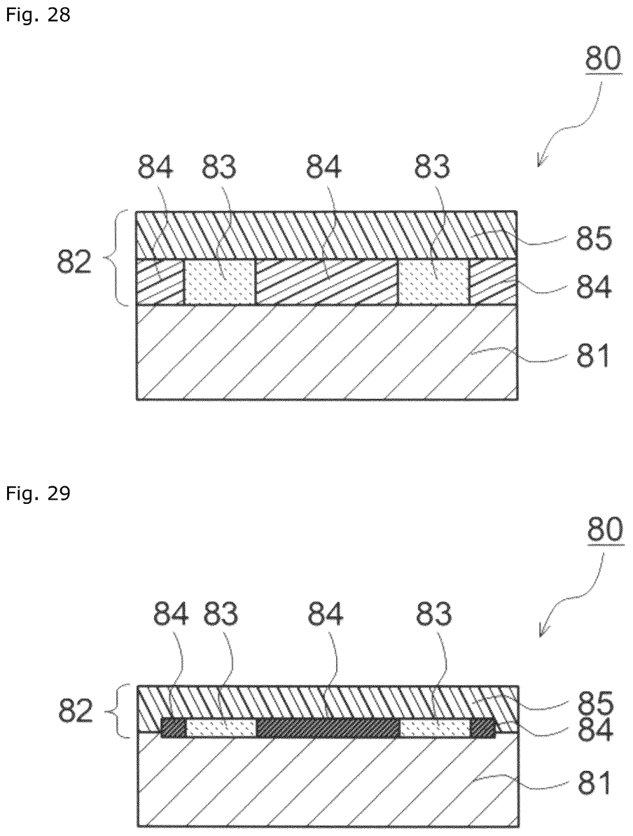

In an embodiment, as illustrated in FIG. 28, a discolored or decolorized printed material 80 includes a transfer-receiving article 81 and a discolored or decolorized retransfer layer 82, in which the discolored or decolorized retransfer layer 82 includes a discolored or decolorized portion 83, a general image 84 formed by fusion transfer, and a receiving layer 85. As illustrated in FIG. 28, the receiving layer 85 is disposed on the opposite side of the discolored or decolorized portion 83 and the general image 84 from the transfer-receiving article 81.

In an embodiment, as illustrated in FIG. 29, the discolored or decolorized printed material 80 includes the transfer-receiving article 81 and the discolored or decolorized retransfer layer 82, in which the discolored or decolorized retransfer layer 82 includes the discolored or decolorized portion 83, the general image 84 formed by sublimation transfer, and the receiving layer 85. As illustrated in FIG. 29, the receiving layer 85 is disposed on the opposite side of the discolored or decolorized portion 83 and the general image 84 from the transfer-receiving article 81. As illustrated in FIG. 29, the discolored or decolorized portion 83 and the general image 84 are disposed on the receiving layer 85.

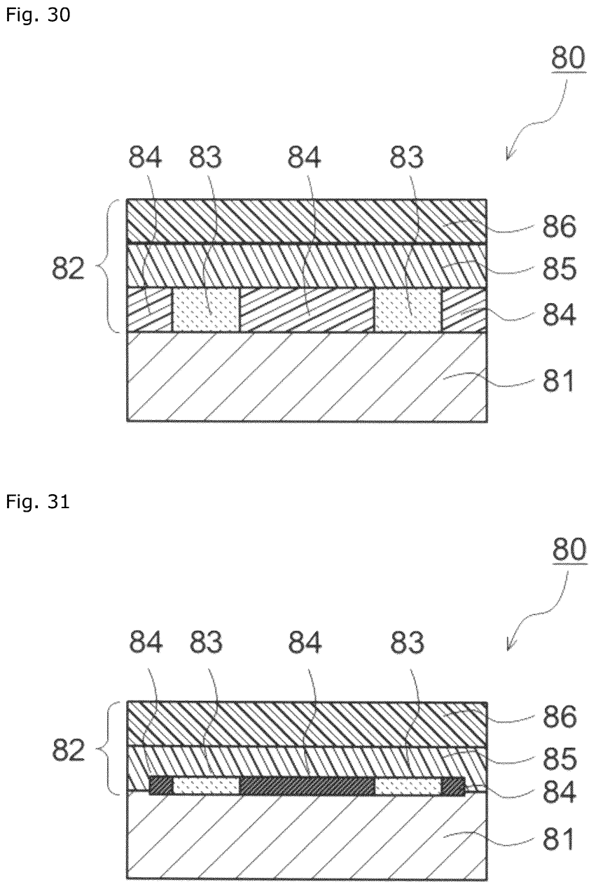

In an embodiment, as illustrated in FIG. 30, the discolored or decolorized printed material 80 includes the transfer-receiving article 81 and the discolored or decolorized retransfer layer 82, in which the discolored or decolorized retransfer layer 82 includes the discolored or decolorized portion 83, the general image 84 formed by fusion transfer, the receiving layer 85, and a protective layer 86. As illustrated in FIG. 30, the receiving layer 85 is disposed on the opposite side of the discolored or decolorized portion 83 and the general image 84 from the transfer-receiving article 81. As illustrated in FIG. 30, the protective layer 86 is disposed on the opposite side of the receiving layer 85 from the discolored or decolorized portion 83 and the general image 84.

In an embodiment, as illustrated in FIG. 31, the discolored or decolorized printed material 80 includes the transfer-receiving article 81 and the discolored or decolorized retransfer layer 82, in which the discolored or decolorized retransfer layer 82 includes the discolored or decolorized portion 83, the general image 84 formed by sublimation transfer, the receiving layer 85, and the protective layer 86. As illustrated in FIG. 31, the receiving layer 85 is disposed on the opposite side of the discolored or decolorized portion 83 and the general image 84 from the transfer-receiving article 81. As illustrated in FIG. 31, the protective layer 86 is disposed on the opposite side of the receiving layer 85 from the discolored or decolorized portion 83 and the general image 84. As illustrated in FIG. 31, the receiving layer 85 is disposed on the opposite side of the discolored or decolorized portion 83 and the general image 84 from the transfer-receiving article 81. As illustrated in FIG. 31, the discolored or decolorized portion 83 and the general image 84 are disposed on the receiving layer 85.

The discolored or decolorized retransfer layer 82 of the discolored or decolorized printed material 80 may include a sublimation transfer discoloration- or decolorization-imparting image (not illustrated) between the transfer-receiving article 81 and the general image 84 and/or between the general image 84 and the receiving layer 85.

The above-described layer configurations of the discolored or decolorized printed material 80 can be combined as appropriate.

The discolored or decolorized printed material of the second form can be produced using the thermal transfer printed material of the second form.

Each layer that can be included in the discolored or decolorized printed material of the second form will be described below.

### <Transfer-Receiving Article>

As the transfer-receiving article of the discolored or decolorized printed material of the second form, the transfer-receiving article described in the thermal transfer printed material of the second form can be used.

### <Discolored or Decolorized Retransfer Layer>

The discolored or decolorized retransfer layer includes at least a receiving layer and a discolored or decolorized portion. The receiving layer may be disposed on the opposite side of the discolored or decolorized portion from the transfer-receiving article.

The discolored or decolorized retransfer layer may further include a general image and/or a sublimation transfer discoloration- or decolorization-imparting image.

The discolored or decolorized retransfer layer may include a protective layer on the opposite side of the receiving layer from the discolored or decolorized portion. The protective layer may be disposed at the outermost surface of the thermal transfer printed material.

The discolored or decolorized retransfer layer can be formed from the retransfer layer of the thermal transfer printed material of the second form.

### (Receiving Layer)

The receiving layer of the discolored or decolorized printed material may include the general image and/or sublimation transfer discoloration- or decolorization-imparting image.

The receiving layer of the discolored or decolorized printed material may contain at least one resin material. Examples of the resin material contained in the receiving layer include polyolefins, vinyl resins, such as poly(vinyl chloride) and vinyl chloride-vinyl acetate copolymers, (meth)acrylic resins, cellulose resins, polyesters, polyamides, polycarbonates, styrene resins, epoxy resins, polyurethanes, and ionomer resins.

The receiving layer of the discolored or decolorized printed material preferably has a resin material content of 80% or more by mass and 99.5% or less by mass, more preferably 85% or more by mass and 99% or less by mass, based on the total component contained in the receiving layer.

The receiving layer of the discolored or decolorized printed material may contain the above-described additive.

The receiving layer of the discolored or decolorized printed material preferably has a thickness of 0.5 μm or more and 20 μm or less, more preferably 1 μm or more and 10 μm or less.

### (Discolored or Decolorized Portion)

The discolored or decolorized portion is a portion where the general image has been discolored or decolorized by the above-described light irradiation.

In an embodiment, the discolored or decolorized portion contains the reaction product of the coloring material contained in the general image and the compound responsible for discoloration or decolorization contained in the sublimation transfer discoloration- or decolorization-imparting image. Examples of the reaction product include the reaction product of the coloring material and the compound responsible for discoloration or decolorization by the above-described light irradiation or the above-described heat treatment; and/or products obtained by initiation of the reaction of the coloring material due to the compound responsible for discoloration or decolorization and then decomposition, breakdown, or polymerization of the coloring material.

### (Sublimation Transfer Discoloration- or Decolorization-Imparting Image)

The sublimation transfer discoloration- or decolorization-imparting image of the discolored or decolorized retransfer layer contains the compound responsible for discoloration or decolorization, the compound having sublimability or diffusibility. The compound responsible for discoloration or decolorization contained in the discoloration- or decolorization-imparting image is, for example, an unreacted component that did not react with the coloring material by the above-described light irradiation.

The sublimation transfer discoloration- or decolorization-imparting image of the discolored or decolorized printed material of the second form may be disposed on the general image and/or the receiving layer.

The sublimation transfer discoloration- or decolorization-imparting image of the discolored or decolorized printed material of the second form can be formed from the sublimation transfer discoloration- or decolorization-imparting image of the thermal transfer printed material of the second form.

### (General Image)

Examples of the general image of the discolored or decolorized retransfer layer include photographs, characters, patterns, symbols, and combinations thereof. The general image of the discolored or decolorized retransfer layer contains the above-described coloring material. The coloring material contained in the general image is, for example, an unreacted component that did not react with the compound responsible for discoloration or decolorization by the above-described light irradiation.

The general image of the discolored or decolorized printed material of the second form may be disposed on the sublimation transfer discoloration- or decolorization-imparting image and/or the receiving layer.

The general image of the discolored or decolorized printed material of the second form can be formed from the general image of the thermal transfer printed material of the second form.

### (Protective Layer)

The protective layer of the discolored or decolorized printed material of the second form may be disposed on the opposite side of the discolored or decolorized portion from the transfer-receiving article. The protective layer may be disposed at the outermost surface of the discolored or decolorized printed material.

As the protective layer of the discolored or decolorized printed material of the second form, the protective layer described in the thermal transfer printed material of the second form can be used.

### [Method for Producing Discolored or Decolorized Printed Material of Second Form]

A method for producing the discolored or decolorized printed material of the second form includes a step of providing the thermal transfer printed material of the second form, and a light irradiation step of performing irradiation with a light beam having a predetermined intensity for a predetermined period of time from a side of the thermal transfer printed material of the second form adjacent to the retransfer layer to discolor or decolorize the general image.

Each step included in the method for producing the discolored or decolorized printed material of the second form will be described below.

### <Step of Providing Thermal Transfer Printed Material>

The method for producing the discolored or decolorized printed material of the second form includes the step of providing the thermal transfer printed material of the second form. Since the method for producing the thermal transfer printed material is as described above, the description thereof is omitted here.

### <Light Irradiation Step>

In an embodiment, the method for producing the discolored or decolorized printed material of the second form includes the light irradiation step of performing irradiation with the light beam having a predetermined intensity for a predetermined period of time from the side of the thermal transfer printed material of the second form adjacent to the retransfer layer to discolor or decolorize the general image. The irradiation with the light beam with a predetermined intensity for a predetermined period of time is, for example, irradiation with a xenon lamp at an irradiation intensity of 0.1 W/m² or more for 0.1 seconds or more.

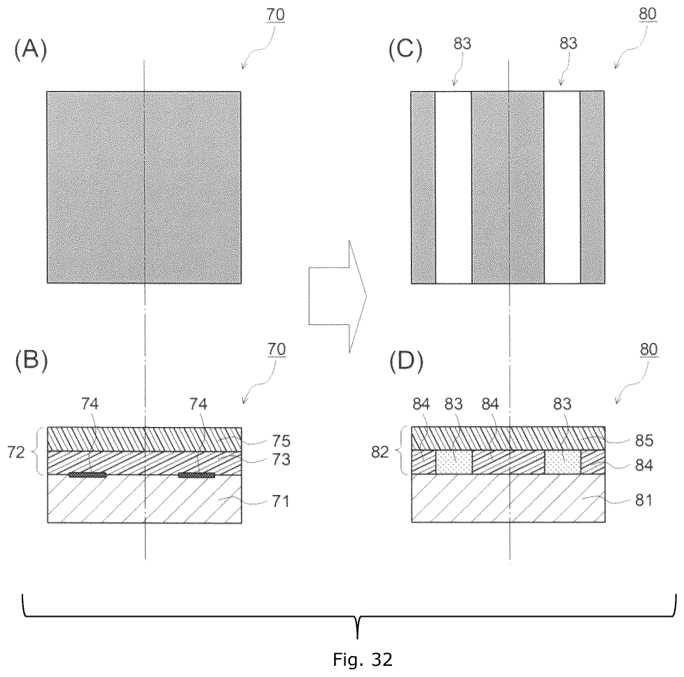

As illustrated in FIG. 32, when the thermal transfer printed material 70 is irradiated with light, part of the general image 73 is discolored or decolorized to form the discolored or decolorized portion 83. Thereby, the discolored or decolorized printed material 80 can be produced. In FIG. 32, (A) is a plan view of the thermal transfer printed material 70, (B) is a cross-sectional view of the thermal transfer printed material 70, (C) is a plan view of the discolored or decolorized printed material 80, and (D) is a cross-sectional view of the discolored or decolorized printed material 70.

The light irradiation intensity is preferably 0.1 W/m² or more and 5 W/m² or less, more preferably 0.1 W/m² or more and 3 W/m² or less. Thereby, the discolored or decolorized portion can be satisfactorily formed.

The light irradiation time is preferably 0.1 seconds or more and 2,160 hours or less, more preferably 1 second or more and 720 hours or less, even more preferably 1 hour or more and 240 hours or less. Thereby, the discolored or decolorized portion can be satisfactorily formed.

Embodiments of a thermal transfer sheet, a combination of a thermal transfer sheet and an intermediate transfer medium, a thermal transfer printed material, a method for producing a thermal transfer printed material, a discolored or decolorized printed material, and a method for producing a discolored or decolorized printed material according to the present disclosure will be described below. The thermal transfer sheet, the combination of the thermal transfer sheet and the intermediate transfer medium, the thermal transfer printed material, the method for producing the thermal transfer printed material, the discolored or decolorized printed material, and the method for producing the discolored or decolorized printed material according to the present disclosure are not limited to these embodiments.

According to the present disclosure, a thermal transfer sheet includes a substrate and a sublimation transfer discoloration- or decolorization-imparting layer disposed on one surface side of the substrate,
in which the sublimation transfer discoloration- or decolorization-imparting layer contains at least a compound responsible for discoloration or decolorization and a binder resin.

In an embodiment, the compound responsible for discoloration or decolorization contains an acid-generating material.

In an embodiment, the acid-generating material is a nonionic acid-generating material.

In an embodiment, the nonionic acid-generating material is a triazine compound.

In an embodiment, the compound responsible for discoloration or decolorization has a molecular weight of 1,000 or less.

In an embodiment, a solid content of the compound responsible for discoloration or decolorization is 10% or more by mass and 90% or less by mass based on the total component contained in the sublimation transfer discoloration- or decolorization-imparting layer.

According to the present disclosure, a thermal transfer printed material includes a transfer-receiving article, a general image, and a sublimation transfer discoloration- or decolorization-imparting image,
in which the sublimation transfer discoloration- or decolorization-imparting image is in contact with at least part of the general image and contains a compound responsible for discoloration or decolorization.

In an embodiment, the thermal transfer printed material is produced using the above-described thermal transfer sheet.

According to the present disclosure, a method for producing the thermal transfer printed material described above includes the steps of:
providing the thermal transfer sheet described above and a transfer-receiving article; and
forming a general image and a sublimation transfer discoloration- or decolorization-imparting image on the transfer-receiving article in such a manner that the general image and the sublimation transfer discoloration- or decolorization-imparting image are in contact with each other,
in which the sublimation transfer discoloration- or decolorization-imparting image is formed from the sublimation transfer discoloration- or decolorization-imparting layer of the thermal transfer sheet.

According to the present disclosure, a discolored or decolorized printed material includes a transfer-receiving article and a discolored or decolorized portion,
in which the discolored or decolorized portion contains a reaction product of a coloring material and a compound responsible for discoloration or decolorization.

In an embodiment, the discolored or decolorized printed material is produced using the above-described thermal transfer printed material.

According to the present disclosure, a method for producing the discolored or decolorized printed material described above includes:
a step of providing the thermal transfer printed material described above; and
a light irradiation step of performing irradiation with a light beam having a predetermined intensity for a predetermined period of time from a side of the thermal transfer printed material adjacent to the general image and the sublimation transfer discoloration- or decolorization-imparting image to discolor or decolorize the general image.

According to the present disclosure, provided is a combination of the thermal transfer sheet described above and an intermediate transfer medium,
in which the intermediate transfer medium includes at least a substrate and a retransfer layer, and
the retransfer layer includes at least a receiving layer.

According to the present disclosure, a thermal transfer printed material includes a transfer-receiving article and a retransfer layer,
in which the retransfer layer includes at least a receiving layer, a general image, and a sublimation transfer discoloration- or decolorization-imparting image, and
the sublimation transfer discoloration- or decolorization-imparting image is in contact with at least part of the general image and contains a compound responsible for discoloration or decolorization.

In an embodiment, the thermal transfer printed material is produced using the above-described combination of the thermal transfer sheet and the intermediate transfer medium.

According to the present disclosure, a method for producing the thermal transfer printed material described above includes the steps of:
providing the combination of the thermal transfer sheet and the intermediate transfer medium described above and the transfer-receiving article;
forming the general image and the sublimation transfer discoloration- or decolorization-imparting image on the receiving layer of the intermediate transfer medium in such a manner that the general image and the sublimation transfer discoloration- or decolorization-imparting image are in contact with each other; and
transferring the retransfer layer including at least the receiving layer, the general image, and the sublimation transfer discoloration- or decolorization-imparting image to the transfer-receiving article,
in which the sublimation transfer discoloration- or decolorization-imparting image is formed from the sublimation transfer discoloration- or decolorization-imparting layer of the thermal transfer sheet.

According to the present disclosure, a discolored or decolorized printed material includes a transfer-receiving article and a discolored or decolorized retransfer layer,
in which the discolored or decolorized retransfer layer includes at least a receiving layer and a discolored or decolorized portion, and
the discolored or decolorized portion contains a reaction product of a coloring material and a compound responsible for discoloration or decolorization.

In an embodiment, the discolored or decolorized printed material is produced using the above-described thermal transfer printed material.

According to the present disclosure, a method for producing the discolored or decolorized printed material described above includes:
a step of providing the thermal transfer printed material described above; and
a light irradiation step of performing irradiation with a light beam having a predetermined intensity for a predetermined period of time from a side of the thermal transfer printed material adjacent to the retransfer layer to discolor or decolorize the general image.

### EXAMPLES

While the present disclosure will be described in more detail below with reference to examples, the present disclosure is not limited to these examples. Hereinafter, with respect to a material in which the proportion of a solid content is described, a content before conversion into a solid content is indicated.

### Example 1

A PET film having a thickness of 4.5 μm was provided as a substrate. Then a coating liquid, having the following composition, for a primer layer was applied to part of one surface of this substrate and dried to form a primer layer having a thickness of 0.10 μm.

### <Coating Liquid for Primer Layer>

| | |
|---|---|
| Alumina sol | 3 parts by mass |
| (Alumina Sol 200, available from Nissan | |
| Chemical Industries, Ltd | |
| Vinyl acetate-vinylpyrrolidone copolymer | 7 parts by mass |
| (PVP/VA E-335, available from ISP Japan KK.) | |
| Water | 100 parts by mass |
| Isopropyl alcohol (IPA) | 100 parts by mass |

Coating liquids A to C, having the following compositions, for coloring material layers were applied onto the primer layer by a wire coating method in such a manner that the resulting coating films were disposed as being frame sequentially on the same surface, and then dried to form coloring material layers A to C each having a thickness of 0.6 μm.

### <Coating Liquid A for Coloring Material Layer>

| | |
|---|---|
| Disperse Yellow 201 | 4 parts by mass |
| Polyvinyl acetal | 3.5 parts by mass |
| (S-LEC (registered trademark) KS-5, | |
| available from Sekisui Chemical Co., Ltd.) | |
| MEK | 46.65 parts by mass |
| Toluene | 46.65 parts by mass |

### <Coating Liquid B for Coloring Material Layer>

| | |
|---|---|
| Disperse Red 60G | 2 parts by mass |
| Disperse Violet 26 | 2 parts by mass |
| Disperse Red 343 | 2 parts by mass |
| Polyvinyl acetal | 3.5 parts by mass |
| (S-LEC (registered trademark) KS-5, | |
| available from Sekisui Chemical Co., Ltd.) | |
| MEK | 46.65 parts by mass |
| Toluene | 46.65 parts by mass |

### <Coating Liquid C for Coloring Material Layer>

| | |
|---|---|
| Solvent Blue 63 | 3.5 parts by mass |
| Disperse Blue 354 | 1 part by mass |
| Polyvinyl acetal | 3.5 parts by mass |
| (S-LEC (registered trademark) KS-5, | |
| available from Sekisui Chemical Co., Ltd.) | |
| MEK | 46.65 parts by mass |
| Toluene | 46.65 parts by mass |

A coating liquid, having the following composition, for a sublimation transfer discoloration- or decolorization-imparting layer was applied onto the primer layer in such a manner that the resulting coating film and the coloring material layers were disposed as being frame sequentially on the same surface, and then dried to form a sublimation transfer discoloration- or decolorization-imparting layer having a thickness of 0.6 μm.

### <Coating Liquid for Sublimation Transfer Discoloration- or Decolorization-Imparting Layer>

Imparting Layer>

| | |
|---|---|
| Polyvinyl acetal | 3.5 parts by mass |
| (S-LEC (registered trademark) | |
| KS-6Z, available from Sekisui | |
| Chemical Co., Ltd.) | |
| Triazine compound A | 3.5 parts by mass |
| (2-(4-methoxystyryl)-4,6- | |
| bis(trichloromethyl)-1,3,5-triazine) | |
| (TAZ-110, molecular weight: 448, | |
| nonionic, available from Midori | |
| Kagaku Co., Ltd.) | |
| MEK | 46.65 parts by mass |
| Toluene | 46.65 parts by mass |

The following coating liquid for a peeling layer was applied in such a manner that the resulting coating film and the coloring material layers were disposed as being frame sequentially on the same surface, and then dried to form a peeling layer having a thickness of 1 μm.

### <Coating Liquid for Peeling Layer>

| | |
|---|---|
| Acrylic resin | 40 parts by mass |
| (LP-45M, available from Soken | |
| Chemical & Engineering Co., Ltd.) | |
| MEK | 30 parts by mass |
| Toluene | 30 parts by mass |

A coating liquid, having the following composition, for an adhesive layer was applied onto the peeling layer and dried to form an adhesive layer having a thickness of 1 μm, thereby resulting in the formation of a protective layer in which the peeling layer and the adhesive layer were laminated.

### <Coating Liquid for Adhesive Layer>

| | |
|---|---|
| Polyester | 30 parts by mass |
| (Vylon (registered trademark) 200, | |
| available from Toyobo Co., Ltd.) | |
| Ultraviolet absorber | 2 parts by mass |
| (Tinuvin 928, available from | |
| BASF Japan Ltd.) | |
| MEK | 34 parts by mass |
| Toluene | 34 parts by mass |

A coating liquid, having the following composition, for a back layer was applied onto a surface of the PET film opposite to the surface on which the discoloration- or decolorization-imparting layer was disposed, and then dried to form a back layer having a thickness of 1 μm, thereby resulting in a thermal transfer sheet.

### <Coating Liquid for Back Layer>

| | |
|---|---|
| Poly(vinyl butyral) | 3.6 parts by mass |
| (S-LEC (registered trademark) BX-1, | |
| available from Sekisui Chemical | |
| Co., Ltd. Co., Ltd.) | |
| Polyisocyanate | 8.4 parts by mass |
| (Burnock (registered trademark) | |
| D750, available from DIC | |
| Corporation) | |
| Phosphate surfactant | 2.8 parts by mass |
| (Plysurf (registered trademark) A208N, | |
| available from DKS Co., Ltd.) | |
| Talc | 0.6 parts by mass |
| (Micro Ace (registered trademark) P-3, | |
| available from Nippon Talc Co., | |
| Ltd.) | |
| Methyl ethyl ketone (MEK) | 42.3 parts by mass |
| Toluene | 42.3 parts by mass |

### Examples 2 to 10 and Comparative Example 1

Thermal transfer sheets were produced as in Example 1, except that configurations of the layers constituting the thermal transfer sheets were changed as given in Table 1. In each of Examples 8 and 9, the coloring material layers and the sublimation transfer discoloration- or decolorization-imparting layer are disposed on the primer layer of the thermal transfer sheet in the order of the sublimation transfer discoloration- or decolorization-imparting layer and the coloring material layer.
Triazine compound B (2-methyl-4,6-bis(trichloromethyl)-1,3,5-triazine): TAZ-100, molecular weight: 330, nonionic, available from Midori Kagaku Co., Ltd.
Triazine compound C (2-(4-(2-(4,6-bis(trichloromethyl)-1,3,5-triazin-2-yl) vinyl) phenoxy) ethanol): TAZ-123, molecular weight: 478, nonionic, available from Midori Kagaku Co., Ltd.
Triazine compound D (2-(2-(2-furan-2-yl) vinyl)-4,6-bis(trichloromethyl)-1,3,5-triazine): TFE-Triazine, molecular weight 408, nonionic, available from Sanwa Chemical Co., Ltd.
Carbamate compound (2-nitrobenzyl cyclohexylcarbamate): NBC-101, molecular weight: 278, nonionic, available from Midori Kagaku Co., Ltd.
Sulfonium salt (triphenylsulfonium trifluoromethanesulfonate): TPS-105, molecular weight: 412, non-sublimable, ionic, available from Midori Kagaku Co., Ltd.
Triazine compound E (2-(methoxyphenyl)-4,6-bis(trichloromethyl)-z-triazine): MP-Triazine, molecular weight: 421.93, nonionic, available from Sanwa Chemical Co., Ltd.

### Comparative Example 2

A PET film having a thickness of 4.5 μm was provided as a substrate. The coating liquid, having the same composition as in Example 1, for a primer layer was applied onto part of one surface of this substrate, and dried to form a primer layer having a thickness of 0.10 μm.

The coating liquids A to C, having the same compositions as in Example 1, for the coloring material layers were applied onto the primer layer in such a manner that the resulting coating films were disposed as being frame sequentially on the same surface, and then dried to form coloring material layers A to C each having a thickness of 0.6 μm.

A coating liquid, having the following composition, for a peeling layer was applied onto the surface of the substrate in such a manner that the resulting coating film and the primer layer were disposed as being frame sequentially on the same surface, and then dried to form a peeling layer having a thickness of 1 μm.

### <Coating Liquid for Peeling Layer>

| | |
|---|---|
| Acrylic resin | 40 parts by mass |
| (LP-45M, available from Soken | |
| Chemical & Engineering Co., Ltd.) | |
| MEK | 30 parts by mass |
| Toluene | 30 parts by mass |

A coating liquid, having the following composition, for a fusion transfer discoloration- or decolorization-imparting layer was applied onto the peeling layer and dried to form a discoloration- or decolorization-imparting layer having a thickness of 0.7 μm.

### <Coating Liquid for Fusion Transfer Discoloration- or Decolorization-Imparting Layer>

| | |
|---|---|
| Polyester | 25 parts by mass |
| (Vylon (registered trademark) | |
| 700, available from Toyobo Co., Ltd.) | |
| Silicon dioxide | 0.5 parts by mass |
| (Sylysia 310, available from Fuji | |
| Silysia Chemical Ltd.) | |
| Phosphate | 3 parts by mass |
| (Plysurf (registered trademark) A208N, | |
| available from Dai-ichi Seiyaku | |
| Kogyo Co., Ltd.) | |

### Comparative Example 3

A thermal transfer sheet was produced as in Comparative Example 2, except that the configuration of layers constituting the thermal transfer sheet was changed as given in Table 1.

TABLE 1

| | | | | | | | | | Binder content of |
|---|---|---|---|---|---|---|---|---|---|
| | | | | | | | | | sublimation transfer |
| | | | | | | | | | discoloration- or |
| | | | | | | | | | decolorization-imparting |
| | Compound responsible for discoloration or decolorization contained in sublimation transfer discoloration- or | | | | | | | | layer or fusion transfer |
| | decolorization-imparting layer and content (% by mass) | | | | | | | | discoloration- or |
| | Triazine | Triazine | Triazine | Triazine | Carbamate | Sulfonium | | Triazine | decolorization-imparting |
| | compound A | compound B | compound C | compound D | compound | salt | Phosphate | compound E | layer (% by mass) |
| Example 1 | 50.0 | | | | | | | | 50.0 |
| Example 2 | 22.2 | | | | | | | | 77.8 |
| Example 3 | 14.6 | | | | | | | | 85.4 |
| Example 4 | | 50.0 | | | | | | | 50.0 |
| Example 5 | | | 50.0 | | | | | | 50.0 |
| Example 6 | | | | 50.0 | | | | | 50.0 |
| Example 7 | | | | | 50.0 | | | | 50.0 |
| Example 8 | 50.0 | | | | | | | | 50.0 |
| Example 9 | 22.2 | | | | | | | | 50.0 |
| Example 10 | | | | | | | | 50.0 | 50.0 |
| Comparative | | | | | | 50.0 | | | 50.0 |
| example 1 | | | | | | | | | |
| Comparative | | | | | | | 10.7 | | 89.3 |
| example 2 | | | | | | | | | |
| Comparative | | | | | | | 5.7 | | 94.3 |
| example 3 | | | | | | | | | |

### [Production of Intermediate Transfer Medium]

A PET film having a thickness of 12 μm was provided as a second substrate. A coating liquid, having the following composition, for a peeling layer was applied onto one surface of this PET film and dried to form a peeling layer having a thickness of 1.6 μm. A coating liquid, having the following composition, for a protective layer was applied onto the peeling layer and dried to form a protective layer having a thickness of 4 μm. A coating liquid, having the following composition, for a receiving layer was applied onto the protective layer and dried to form a receiving layer having a thickness of 2 μm, thereby resulting in an intermediate transfer medium. The peeling layer, the protective layer, and the receiving layer constitute the retransfer layer of the intermediate transfer medium.

### <Coating Liquid for Peeling Layer>

| | |
|---|---|
| Vinyl chloride-vinyl acetate copolymer | 85 parts by mass |
| (Solbin (registered trademark) CNL, | |
| available from Nissin Chemical | |
| Industry Co., Ltd.) | |
| (Meth)acrylic resin | 15 parts by mass |
| (Vanaresin GH-8701, available from | |
| Shin-Nakamura Chemical Co., Ltd.) | |
| Epoxy-modified silicone oil | 2 parts by mass |
| (KP-1800U, available from Shin-Etsu | |
| Chemical Co., Ltd.) | |
| MEK | 150 parts by mass |
| Toluene | 150 parts by mass |

### <Coating Liquid for Protective Layer>

| | |
|---|---|
| Polyester | 20 parts by mass |
| (Elitel (registered trademark) | |
| UE-9885, available from Unitika Ltd.) | |
| MEK | 40 parts by mass |
| Toluene | 40 parts by mass |

### <Coating Liquid for Receiving Layer>

| | |
|---|---|
| Vinyl chloride-vinyl acetate copolymer | 95 parts by mass |
| (Solbin (registered trademark) CNL, | |
| Tg: 76° C., Mn: 16,000, available | |
| from Nissin Chemical Industry Co., Ltd.) | |
| Epoxy-modified silicone oil | 5 parts by mass |
| (KP-1800U, available from Shin-Etsu | |
| Chemical Co., Ltd.) | |
| MEK | 200 parts by mass |
| Toluene | 200 parts by mass |

### [Production of Thermal Transfer Printed Material 1 of First Form]

Using the thermal transfer sheet obtained in each of Examples 1 to 7 and 10 and Comparative example 1, black printing was performed on image-receiving paper for a thermal transfer printer (DS620), available from Dai Nippon Printing Co., Ltd., with the following evaluation printer, thereby forming general images. The black printing was performed by transferring the coloring materials contained in the coloring material layers A to C (0/255 image gradation).

### <Evaluation Printer>

Thermal head: F3598 (available from Toshiba Hokuto Electronics Corporation)·
Average resistance of heating element: 5,015 (Ω)
Print density in main-scanning direction: 300 (dpi)
Print density in sub-scanning direction: 300 (dpi)
Printing power: 0.21 (W/dot)
Applied voltage: 25.5 (V)
Line period: 2 (msec./line)
Pulse duty: 85%

The sublimation transfer discoloration- or decolorization-imparting layer of the thermal transfer sheet was transferred by sublimation onto the black pattern with the above-described printer under the above-described conditions (provided that the printing power was 0.12 (W/dot)) to form characters “TEST” as a sublimation transfer discoloration or decolorization image.

The protective layer was transferred onto the general image and the sublimation transfer discoloration or decolorization image using the above-described printer under the above-described conditions (provided that the printing power was 0.12 (W/dot)) to produce a thermal transfer printed material of a first form.

With regard to the thermal transfer sheet obtained in each of Examples 8 and 9, a thermal transfer printed material of a first form was produced with the same printer under the same conditions as described above, except that the sublimation transfer discoloration or decolorization image (characters of “TEST”) was formed on the image-receiving paper, and then a general image was formed.

With regard to the thermal transfer sheets obtained in each of Comparative examples 2 and 3, a thermal transfer printed material of the first form was produced in the same manner as described above, except that the fusion transfer discoloration- or decolorization-imparting layer of the thermal transfer sheet was transferred by fusion transfer onto the black pattern with the above-described printer under the above-described conditions to form the characters of “TEST” as a fusion transfer discoloration or decolorization image.

### [Production of Thermal Transfer Printed Material 1 of Second Form]

Using the thermal transfer sheet obtained in each of Examples 1 to 7 and 10 and Comparative example 1, black printing was performed on the receiving layer of the intermediate transfer medium with the following evaluation printer to form a general image. The black printing was performed by transferring the coloring materials contained in the coloring material layers A to C (0/255 image gradation).

### <Evaluation Printer>

Thermal head: KEE-57-12GAN-STA (available from Kyocera Corporation)
Average resistance of heating element: 3,303 (Ω)
Print density in main-scanning direction: 300 (dpi)
Print density in sub-scanning direction: 300 (dpi)
Printing voltage: 18 (V)
1 line period: 1.5 (msec.)
Pulse duty ratio: 85%
Printing start temperature: 35 (° C.)

The sublimation transfer discoloration- or decolorization-imparting layer of the thermal transfer sheet was transferred onto the black pattern using the above-described printer under the above-described conditions to form characters “TEST” as a sublimation transfer discoloration or decolorization image.

The peeling layer, the protective layer, the receiving layer, the general image, and the sublimation transfer discoloration- or decolorization-imparting image included in the intermediate transfer medium were retransferred to a card having the following composition with the following laminator under the following conditions to produce a thermal transfer printed material of a second form.

### <Laminator>

Laminator: Lamipacker LPD3212 (available from Fujipla Inc.)
Temperature: 145° C.
Speed: 0.8 (set value)

### <Card>

| | |
|---|---|
| Poly(vinyl chloride) compound | 100 parts by mass |
| (degree of polymerization: 800, | |
| containing about 10% of additives | |
| such as stabilizers) | |
| White pigment (titanium oxide) | 10 parts by mass |
| Plasticizer (DOP) | 0.5 parts by mass |

With regard to the thermal transfer sheet obtained in each of Examples 8 and 9, a thermal transfer printed material of a second form was produced with the same printer and the same laminator under the same conditions as described above, except that the sublimation transfer discoloration or decolorization image (characters of “TEST”) was formed on the receiving layer of the intermediate transfer medium, and then a general image was formed.

With regard to the thermal transfer sheets obtained in each of Comparative examples 2 and 3, a thermal transfer printed material of a second form was produced in the same manner as described above, except that the fusion transfer discoloration- or decolorization-imparting layer of the thermal transfer sheet was transferred by fusion transfer onto the black pattern with the above-described printer under the above-described conditions to form the characters of “TEST” as a fusion transfer discoloration or decolorization image.

### <<Evaluation of Transferability and Design>>

The thermal transfer printed material materials of the first form and the second form obtained above were visually observed, and whether the positions of the characters “TEST” could be recognized was evaluated based on the following evaluation criteria. Table 2 presents the evaluation results.

### (Evaluation Criteria)

A: The sublimation transfer discoloration- or decolorization-imparting agent was transferred, and the positions of the characters “TEST” could not be recognized.
B: The sublimation transfer discoloration- or decolorization-imparting agent was transferred, and the positions of the characters “TEST” could be recognized by the difference in color.
C: The fusion transfer discoloration- or decolorization-imparting layer was transferred, and the positions of the characters “TEST” could be recognized by an optical difference.
NG: The sublimation transfer discoloration- or decolorization-imparting agent was not transferred.

TABLE 2

| | Evaluation of transferability and design | |
|---|---|---|
| | Thermal transfer | Thermal transfer |
| | printed | printed |
| | material 1 of | material 1 of |
| | first form | second form |
| Example 1 | B | B |
| Example 2 | B | B |
| Example 3 | B | B |
| Example 4 | B | B |
| Example 5 | B | B |
| Example 6 | B | B |
| Example 7 | B | B |
| Example 8 | B | B |
| Example 9 | B | B |
| Example 10 | A | A |
| Comparative | NG | NG |
| example 1 | | |
| Comparative | C | C |
| example 2 | | |
| Comparative | C | C |
| example 3 | | |

### <<Evaluation of Discoloration or Decolorization Properties>>

### [Production of Thermal Transfer Printed Material 2 of First Form]

Using the thermal transfer sheets obtained in each of Examples 1 to 3 and 10 and Comparative example 1, black printing was performed on image-receiving paper for a thermal transfer printer (DS620), available from Dai Nippon Printing Co., Ltd., with the following evaluation printer, thereby forming a general image. The black printing was performed by transferring the coloring materials contained in the coloring material layers A to C (0/255 image gradation).

### <Evaluation Printer>

Thermal head: F3598 (available from Toshiba Hokuto Electronics Corporation)
Average resistance of heating element: 5,015 (Ω)
Print density in main-scanning direction: 300 (dpi)
Print density in sub-scanning direction: 300 (dpi)
Printing power 0.21 (W/dot)
Applied voltage: 25.5 (V)
Line period: 2 (msec./line)
Pulse duty: 85%

The sublimation transfer discoloration- or decolorization-imparting layer of the thermal transfer sheet was transferred onto the black pattern at transfer energies of 0.22 (mJ/dot), 0.165 (mJ/dot), and 0.11 (mJ/dot) to form a gradation pattern with the above-described printer under the above-described conditions.

The protective layer was transferred onto the general image and the sublimation transfer discoloration or decolorization image with the above-described printer under the above-described conditions (provided that the printing power was 0.12 (W/dot)) to produce a thermal transfer printed material 2 of a first form.

### [Production of Thermal Transfer Printed Material 2 of Second Form]

Using the thermal transfer sheet obtained in each of Examples 1 to 3 and 10 and Comparative example 1, black printing was performed on the receiving layer of the intermediate transfer medium with the following evaluation printer to form a general image. The black printing was performed by transferring the coloring materials contained in the coloring material layers A to C (0/255 image gradation).

### <Evaluation Printer>

Thermal head: KEE-57-12GAN-STA (available from Kyocera Corporation)
Average resistance of heating element: 3,303 (Ω)
Print density in main-scanning direction: 300 (dpi)
Print density in sub-scanning direction: 300 (dpi)
Printing voltage: 18 (V)
1 line period: 1.5 (msec.)
Pulse duty ratio: 85%
Printing start temperature: 35 (° C.)

The sublimation transfer discoloration- or decolorization-imparting layer of the thermal transfer sheet was transferred onto the black pattern at transfer energies of 0.22 (mJ/dot), 0.165 (mJ/dot), and 0.11 (mJ/dot) to form a gradation pattern with the above-described printer under the above-described conditions.

The peeling layer, the protective layer, the receiving layer, the general image, and the sublimation transfer discoloration- or decolorization-imparting image included in the intermediate transfer medium were retransferred to a card having the following composition with the following laminator under the following conditions to produce a thermal transfer printed material 2 of a second form.

### <Laminator>

Laminator: Lamipacker LPD3212 (available from Fujipla Inc.)
Temperature: 145° C.
Speed: 0.8 (set value)

### <Card>

| | |
|---|---|
| Poly(vinyl chloride) compound | 100 parts by mass |
| (degree of polymerization: 800, | |
| containing about 10% of additives | |
| such as stabilizers) | |
| White pigment (titanium oxide) | 10 parts by mass |
| Plasticizer (DOP) | 0.5 parts by mass |

### [Evaluation]

With regard to the printed material immediately after the production of each of the thermal transfer printed materials 2 of the first form and the second form, the image density (OD value) in the region to which the sublimation transfer discoloration- or decolorization-imparting layer had been transferred was measured with an optical densitometer (i1Pro2, available from X-Rite Inc.) under the following measurement conditions.

### (Measurement Conditions)

Density status: Status A
Light source: D65
Measurement field of view: 2°
Measurement illumination conditions: MO (ISO 13655-2009)

The hues L*, a*, and b* were measured for an area where the image density was measured (test area) (L*, a*, and b* are based on the CIE 1976 L*a*b* color system (JIS Z 8729 (published in 1980), where L* represents lightness and a* and b* represent chromaticness indices).

Irradiation was performed for 48 hours under the following irradiation conditions using a xenon weather meter (Ci4000, available from Atlas). The image density and hue of the test area were measured again.

The density change ΔOD and hue change ΔE*ab were calculated from the following equations. Table 3 presents the results.

$$Density change Δ OD = OD value before irradiation - OD value after irradiation$$

$$Hue change = {( {L}^{*} after irradiation - {L}^{*} before irradiation )}^{2} +$$

$${( {a}^{*} after irradiation - {a}^{*} before irradiation )}^{2} +$$

$${{( {b}^{*} after irradiation - {b}^{*} before irradiation )}^{2} )}^{1 / 2}$$

### (Irradiation Conditions)

Black panel temperature: 45° C.
Filter: (inner) quartz, (outer) soda lime+CIRA
Environment in testing chamber: temperature: 30° C., humidity: 30%
Irradiation control: irradiation with ultraviolet radiation having a wavelength of 420 nm at 1.2 W/m² (constant)

TABLE 3

| | Evaluation of Discoloration or Decolorization Properties | | | | | | | | | | | |
|---|---|---|---|---|---|---|---|---|---|---|---|---|
| | Thermal transfer printed material 2 of first form | | | | | | Thermal transfer printed material 2 of second form | | | | | |
| | Density change ΔOD | | | Hue change ΔE*ab | | | Density change ΔOD | | | Hue change ΔE*ab | | |
| | Transfer energy for sublimation transfer discoloration or decolorization layer [mJ/dot] | | | | | | | | | | | |
| | 0.22 | 0.165 | 0.11 | 0.22 | 0.165 | 0.11 | 0.22 | 0.165 | 0.11 | 0.22 | 0.165 | 0.11 |
| Example 1 | 0.77 | 0.59 | 0.31 | 42.49 | 36.4 | 17.85 | 0.82 | 0.61 | 0.3 | 41.25 | 35.8 | 17.52 |
| Example 2 | 0.64 | 0.47 | 0.24 | 36.62 | 28.98 | 14.59 | 0.6 | 0.45 | 0.25 | 34.8 | 24.85 | 13.22 |
| Example 3 | 0.61 | 0.41 | 0.27 | 44.55 | 26.83 | 15.4 | 0.62 | 0.37 | 0.25 | 45.01 | 23.25 | 13.49 |
| Example 10 | 0.7 | 0.55 | 0.25 | 40.88 | 31.25 | 15.2 | 0.78 | 0.62 | 0.26 | 43.2 | 32.24 | 16.11 |
| Comparative | 0.12 | 0.08 | 0.05 | 4.88 | 3.52 | 2.22 | 0.1 | 0.07 | 0.05 | 4.89 | 3.72 | 2.57 |
| example 1 | | | | | | | | | | | | |

It should be understood by those skilled in the art that the thermal transfer sheet and the like of the present disclosure are not limited by the description of the above examples, but the above examples and specification are merely for illustrating the principle of the present disclosure, and various modifications or improvements can be made without departing from the spirit and scope of the present disclosure, and all of these modifications or improvements fall within the scope of the present disclosure as claimed. Furthermore, the scope of protection claimed by the present disclosure includes not only the description of the claims but also the equivalents thereof.

### REFERENCE SIGNS LIST

10: thermal transfer sheet, 11: substrate (first substrate), 12: coloring material layer, 13: sublimation transfer discoloration- or decolorization-imparting layer, 14: protective layer (first protective layer), 30: combination of thermal transfer sheet and intermediate transfer medium, 40: intermediate transfer medium, 41: substrate (second substrate), 42: retransfer layer, 43: receiving layer (second receiving layer), 50: thermal transfer printed material, 51: transfer-receiving article, 52: general image, 53: sublimation transfer discoloration- or decolorization-imparting image, 54: protective layer, 60: discolored or decolorized printed material, 61: transfer-receiving article, 62: discolored or decolorized portion, 63: general image, 64: protective layer, 70: thermal transfer printed material, 71: transfer-receiving article, 72: retransfer layer, 73: general image, 74: sublimation transfer discoloration- or decolorization-imparting image, 75: receiving layer, 76: protective layer, 80: discolored or decolorized printed material, 81: transfer-receiving article, 82: discolored or decolorized retransfer layer, 83: discolored or decolorized portion, 84: general image, 85: receiving layer, 86: protective layer

1. A method for producing a thermal transfer printed material, comprising the steps of:
providing a thermal transfer sheet and a transfer-receiving article, wherein the thermal transfer sheet includes
a substrate, and
a sublimation transfer discoloration- or decolorization-imparting layer disposed on one surface side of the substrate,
wherein the sublimation transfer discoloration- or decolorization-imparting layer contains at least a compound responsible for discoloration or decolorization and a binder resin, the compound having sublimability or diffusibility and a function of discoloring or decolorizing a general image;
forming a general image and a sublimation transfer discoloration- or decolorization-imparting image on the transfer-receiving article in such a manner that the general image and the sublimation transfer discoloration- or decolorization-imparting image are in contact with each other,
wherein the sublimation transfer discoloration- or decolorization-imparting image is formed from the sublimation transfer discoloration- or decolorization-imparting layer of the thermal transfer sheet, and
wherein the thermal transfer printed material includes the transfer-receiving article, the general image, and the sublimation transfer discoloration- or decolorization-imparting image,
the transfer-receiving article includes a receiving layer, and the general image and/or the sublimation transfer discoloration- or decolorization-imparting image are disposed on the receiving layer,
the general image is a thermal transfer image, and
the sublimation transfer discoloration- or decolorization-imparting image is in contact with at least part of the general image and contains a compound responsible for discoloration or decolorization, the compound having sublimability or diffusibility and a function of discoloring or decolorizing the general image.

2. A combination of a thermal transfer sheet and an intermediate transfer medium,
wherein the thermal transfer sheet includes;
a substrate, and
a sublimation transfer discoloration- or decolorization-imparting layer disposed on one surface side of the substrate,
wherein the sublimation transfer discoloration- or decolorization-imparting layer contains at least a compound responsible for discoloration or decolorization and a binder resin, the compound having sublimability or diffusibility and a function of discoloring or decolorizing a general image,
wherein the intermediate transfer medium includes at least a substrate and a retransfer layer, and
the retransfer layer includes at least a receiving layer.

3. A thermal transfer printed material, comprising a transfer-receiving article and a retransfer layer,
wherein the retransfer layer includes at least a receiving layer, a general image, and a sublimation transfer discoloration- or decolorization-imparting image, and
the sublimation transfer discoloration- or decolorization-imparting image is in contact with at least part of the general image and contains a compound responsible for discoloration or decolorization, the compound having sublimability or diffusibility and a function of discoloring or decolorizing the general image.

4. A method for producing the thermal transfer printed material according to claim 3, comprising the steps of:
providing a combination of a thermal transfer sheet and an intermediate transfer medium and the transfer-receiving article,
wherein the thermal transfer sheet includes a substrate and a sublimation transfer discoloration- or decolorization-imparting layer disposed on one surface side of the substrate,
wherein the sublimation transfer discoloration- or decolorization-imparting layer contains at least a compound responsible for discoloration or decolorization and a binder resin, the compound having sublimability or diffusibility and a function of discoloring or decolorizing a general image and
wherein the intermediate transfer medium includes at least a substrate and a retransfer layer, and the retransfer layer includes at least a receiving layer;
forming the general image and the sublimation transfer discoloration- or decolorization-imparting image on the receiving layer of the intermediate transfer medium in such a manner that the general image and the sublimation transfer discoloration- or decolorization-imparting image are in contact with each other; and
transferring the retransfer layer including at least the receiving layer, the general image, and the sublimation transfer discoloration- or decolorization-imparting image to the transfer-receiving article,
wherein the sublimation transfer discoloration- or decolorization-imparting image is formed from the sublimation transfer discoloration- or decolorization-imparting layer of the thermal transfer sheet.

5. A discolored or decolorized printed material, comprising a transfer-receiving article and a discolored or decolorized retransfer layer,
wherein the discolored or decolorized retransfer layer includes at least a receiving layer and a discolored or decolorized portion, and
the discolored or decolorized portion contains a reaction product of a coloring material and a compound responsible for discoloration or decolorization, the compound having sublimability or diffusibility and a function of discoloring or decolorizing a general image.

6. A method for producing the discolored or decolorized printed material according to claim 5, comprising:
a step of providing a thermal transfer printed material including a transfer-receiving article and a retransfer layer,
wherein the retransfer layer includes at least a receiving layer, a general image, and a sublimation transfer discoloration- or decolorization-imparting image, and
the sublimation transfer discoloration- or decolorization-imparting image is in contact with at least part of the general image and contains a compound responsible for discoloration or decolorization, the compound having sublimability or diffusibility and a function of discoloring or decolorizing the general image; and
a light irradiation step of performing irradiation with a light beam having a predetermined intensity for a predetermined period of time from a side of the thermal transfer printed material adjacent to the retransfer layer to discolor or decolorize the general image.
